(19) United States
(12) Patent Application Publication
(10) Pub. No.: US 2019/0391582 A1
(43) Pub. Date: Dec. 26, 2019

(54) APPARATUS AND METHOD FOR CONTROLLING THE DRIVING OF A VEHICLE

(71) Applicant: LG ELECTRONICS INC., Seoul (KR)

(72) Inventor: Soon Hong JUNG, Gyeonggi-do (KR)

(21) Appl. No.: 16/563,411

(22) Filed: Sep. 6, 2019

(30) Foreign Application Priority Data
Aug. 20, 2019 (KR) 10-2019-0101919

(51) Int. Cl. G05D 1/00; B60W 30/14; B60W 30/09; B60W 30/18; H04L 29/08; G06N 20/00

(52) U.S. Cl. CPC G05D 1/0088; B60W 30/14; B60W 30/09; B60W 30/18163; H04W 84/042; G06N 20/00; B60W 2550/20; G05D 2201/0213; H04L 67/12

(57) ABSTRACT

Disclosed is a method for controlling driving of a vehicle operating an apparatus for controlling driving of a vehicle by executing an artificial intelligence (AI) algorithm and/or machine learning algorithm in a 5G environment connected for the Internet of Things. The method for controlling driving of a vehicle may include controlling a host vehicle in an adaptive cruise mode so that a distance between the host vehicle and a preceding vehicle or a following vehicle is maintained within a predetermined distance based on a driving environment information of the host vehicle and a vehicle information of the preceding vehicle or the following vehicle, and controlling the host vehicle in an adaptive avoidance mode when the distance between the host vehicle and the preceding vehicle or the distance between the host vehicle and the following vehicle is not maintained within the predetermined distance.

### CROSS-REFERENCE TO RELATED APPLICATION

This application claims benefit of priority to Korean Patent Application No. 10-2019-0101919, filed on Aug. 20, 2019, the entire disclosure of which is incorporated herein by reference.

### BACKGROUND

### 1. Technical Field

The present disclosure relates to an apparatus and method for controlling driving of a vehicle, and more particularly, to an apparatus and method for controlling driving of a vehicle capable of controlling a host vehicle to drive while maintaining an adaptive distance from another vehicle by recognizing a real-time change in space based on approaching vehicles and driving environment information around the host vehicle.

### 2. Description of Related Art

A vehicle is equipped with various vehicle safety systems in consideration of convenience and safety of a driver. In recent years, the number of vehicles using a smart cruise control (SCC) system is increasing. The smart cruise control system is a system that controls a vehicle to maintain a vehicle-to-vehicle distance by measuring a distance from a preceding vehicle using a radar.

Related art 1 discloses a method for preventing dangerous situations from occurring by receiving operation information of other approaching vehicles and predicting a change in distance between a host vehicle and the other vehicles.

In addition, related art 2 discloses a method for improving convenience of a driver by automatically controlling a steering angle to match a driving direction of a recognized preceding vehicle (preceding vehicle) and a vehicle speed to constantly maintain a distance from the preceding vehicle, when executing a smart cruise control.

That is, the related art 1 and the related art 2 can maintain a distance from the preceding vehicle by controlling the driving of the host vehicle in response to the driving direction, the speed, and the like of the preceding vehicle. However, the related art 1 and the related art 2 cannot perform adaptive cruise control by application of driving patterns of the preceding vehicle and the following vehicle while the preceding vehicle and the following vehicle are driving in close proximity to each other, and therefore have a problem in that it is difficult to adaptively control the driving of the vehicle in response to the real-time change in space.

The above-described background art is technical information retained by the inventor to derive the present disclosure or acquired by the inventor while deriving the present disclosure, and thus should not be construed as art that was publicly known prior to the filing date of the present disclosure.

### RELATED ART DOCUMENT

### Patent Document

(Patent Document 1) Korea Patent No. 10-1511864 (registered on Apr. 7, 2015)

(Patent Document 2) Korean Patent Laid-Open Publication No. 10-2016-0004115 (published Jan. 12, 2016)

### SUMMARY OF THE INVENTION

An aspect of the present disclosure is to control a host vehicle to drive while maintaining an adaptive distance from other vehicles by recognizing a real-time change in space based on an approaching vehicle and driving environment information around the host vehicle

An aspect of the present disclosure is to improve safety and reliability of an apparatus for controlling driving of a vehicle by recognizing a real-time change in space to enable an adaptive driving control in response to the real-time change in space.

An aspect of the present disclosure is to improve accuracy and performance of an apparatus for controlling driving of a vehicle by calculating a collision probability in consideration of driving patterns of approaching vehicles to enable adaptive avoidance driving control.

An aspect of the present disclosure is to appropriately cope with various situations by applying an adaptive cruise mode and an adaptive avoidance mode according to a scenario while both a preceding vehicle and a following vehicle are driving in close proximity to each other.

An aspect of the present disclosure is to improve user satisfaction by outputting a warning alarm to a preceding vehicle and a following vehicle to enable a quick response.

An aspect of the present disclosure is to reduce possibility of accidents and improve reliability of products by performing adaptive avoidance driving in consideration of information on approaching vehicles tracked for a predetermined time.

An aspect of the present disclosure is to improve performance of an apparatus for controlling driving of a vehicle by more accurately and safely controlling an autonomous driving of the apparatus for controlling driving of a vehicle using artificial intelligence and/or machine learning algorithm.

An aspect of the present disclosure is not limited to the above-mentioned aspects, and other aspects and advantages of the present disclosure, which are not mentioned, will be understood through the following description, and will become apparent from the embodiments of the present disclosure. In addition, it will be understood that the objects and the advantages of the present disclosure can be realized by the means recited in claims and a combination thereof.

A method for controlling driving of a vehicle according to an aspect of the present disclosure may include controlling a host vehicle to drive while maintaining an adaptive distance from other vehicles by recognizing a real-time change in space based on approaching vehicles and driving environment information around the host vehicle.

Specifically, a method for controlling an apparatus for controlling driving of a vehicle may include: checking approaching vehicles located in a predetermined distance with respect to a host vehicle; acquiring at least one of driving environment information including vehicle information of the host vehicle and road traffic information, vehicle information of a preceding vehicle located in front of the host vehicle and vehicle information of a following vehicle located behind the host vehicle among the approaching vehicles; controlling the host vehicle in an adaptive cruise mode so that a distance between the host vehicle and the preceding vehicle or the following vehicle is maintained within a predetermined distance based on the driving environment information of the host vehicle and the vehicle information of the preceding vehicle or the following vehicle; and controlling the host vehicle in an adaptive avoidance mode when the distance between the host vehicle and the preceding vehicle or the distance between the host vehicle and the following vehicle is not maintained within the predetermined distance.

According to the method for controlling driving of a vehicle in accordance with the aspect of the present disclosure, it is possible to control the host vehicle to drive while maintaining the adaptive distance from other vehicles by recognizing the real-time change in space based on the approaching vehicle and the driving environment information around the host vehicle

Further, the acquiring may include receiving the driving environment information of the host vehicle and the vehicle information of the preceding vehicle and the following vehicle based on a downlink grant of a 5G network connected to operate the host vehicle equipped with the apparatus for controlling driving of a vehicle in an autonomous driving mode, and at least a part of the driving environment information of the host vehicle may be received from an intelligent transport system (ITS) server connected to the 5G network.

According to the acquiring of the information in accordance with the aspect of the present disclosure, it is possible to improve the safety and reliability of the apparatus for controlling driving of a vehicle by recognizing the real-time change in space to enable the adaptive driving control in response to the real-time change in space.

Further, the controlling of the host vehicle in the adaptive avoidance mode may include: calculating at least one of a time to collision (TTC) calculated based on the vehicle information of the preceding vehicle and the distance between the host vehicle and the preceding vehicle and a time to collision calculated based on the vehicle information of the following vehicle and the distance between the host vehicle and the following vehicle; and determining that at least one of the preceding vehicle and the following vehicle is located in a collision reserve section based on the time to collision or determining that at least one of the preceding vehicle and the following vehicle is located in a collision danger section.

According to the controlling of the host vehicle in the adaptive avoidance mode in accordance with the aspect of the present disclosure, it is possible to improve the accuracy and performance of the apparatus for controlling driving of a vehicle by calculating the collision probability in consideration of the driving patterns of the approaching vehicles to enable the adaptive avoidance driving control.

Further, the controlling of the host vehicle in the adaptive avoidance mode may include: warning the preceding vehicle when the preceding vehicle is located in the collision reserve section and a speed of the preceding vehicle is equal to or smaller than a threshold value; decelerating the host vehicle corresponding to the speed of the preceding vehicle when the preceding vehicle is located in the collision reserve section and the following vehicle is located in a section other than the collision reserve section and the collision danger section; warning the following vehicle when the preceding vehicle is located in the collision reserve section and the following vehicle is located in the collision reserve section; and determining whether the host vehicle performs a lane change when the preceding vehicle is located in the collision reserve section and the following vehicle is located in the collision danger section.

Further, the controlling of the host vehicle in the adaptive avoidance mode may include: warning the preceding vehicle when the preceding vehicle is located in the collision danger section and a speed of the preceding vehicle is equal to or smaller than a threshold value; decelerating the host vehicle corresponding to the speed of the preceding vehicle when the preceding vehicle is located in the collision danger section and the following vehicle is located in a section other than the collision reserve section and the collision danger section; and warning the following vehicle and determining whether the host vehicle performs a lane change when the preceding vehicle is located in the collision danger section and the following vehicle is located in the collision reserve section or the collision danger section.

Further, the controlling of the host vehicle in the adaptive avoidance mode may include: accelerating the host vehicle corresponding to the speed of the following vehicle when the following vehicle is located in the collision reserve section and the preceding vehicle is located in a section other than the collision reserve section and the collision danger section; warning the preceding vehicle when the following vehicle is located in the collision reserve section and the preceding vehicle is located in the collision reserve section; and determining whether the host vehicle performs a lane change when the following vehicle is located in the collision reserve section and the preceding vehicle is located in the collision danger section.

Further, the controlling of the host vehicle in the adaptive avoidance mode may include: accelerating the host vehicle corresponding to the speed of the following vehicle when the following vehicle is located in the collision danger section and the preceding vehicle is located in a section other than the collision reserve section and the collision danger section; and warning the following vehicle and determining whether the host vehicle performs a lane change when the following vehicle is located in the collision danger section and the following vehicle is located in the collision reserve section or the collision danger section.

According to the controlling of the host vehicle in the adaptive avoidance mode in accordance with the aspect of the present disclosure, it is possible to appropriately cope with various situations by applying the adaptive cruise mode and the adaptive avoidance mode according to a scenario while both the preceding vehicle and the following vehicle are driving in close proximity to each other to thereby enable the more stable driving and improve the user satisfaction.

Further, the determining whether the host vehicle performs the lane change may include: determining whether a lane exist on left and right sides of the host vehicle and a vehicle exists behind the left and right sides of the host vehicle; setting a movable lane of the host vehicle and a movable space of the movable lane; calculating a time to collision based on the vehicle information of the following vehicle of the movable lane, and a distance between a reference point of the movable space and the following vehicle; and performing the lane change of the host vehicle to the lane when the time to collision increases.

According to the determining whether the host vehicle can change a lane in accordance with the aspect of the present disclosure, it is possible to improve the prevention possibility of accidents and improve the accuracy by predicting the movement of the preceding vehicle and the following vehicle, the movement of the vehicle on the lane change road, and predicting the change in the driving environment to perform the lane change.

Further, the checking of the approaching vehicle may include: acquiring and tracking the vehicle information of the approaching vehicle for a predetermined time; acquiring road traffic information from an ITS server for the predetermined time; and analyzing a driving pattern of the approaching vehicle based on the tracking information and the road traffic information of the approaching vehicle for the predetermined time.

According to the confirming of the approaching vehicle in accordance with the aspect of the present disclosure, it is possible to reduce the possibility of accidents and improve the reliability of products by performing the adaptive avoidance driving in consideration of the information on the approaching vehicles tracked for a predetermined time.

Further, the method may further include: receiving, as an input data, the vehicle information of the host vehicle, road traffic information from an ITS server, and vehicle information of the approaching vehicle located within the predetermined distance with respect to the host vehicle; applying the received input data to a learning model to extract an adaptive driving data of the host vehicle in response to a change in space around the host vehicle; and outputting the adaptive driving data in response to the change in space around the host vehicle from the learning model, in which the learning model may be learned to generate the adaptive driving data according to the adaptive cruise mode or the adaptive avoidance mode based on the pre-calculated change state in space around the host vehicle and the plurality of pre-input data to correspond to the vehicle information of the host vehicle and the road traffic information and vehicle information data of the approaching vehicle, respectively, which are input in advance to recognize the change in space around the host vehicle.

According to the method for controlling driving of a vehicle in accordance with the aspect of the present disclosure, it is possible to improve the performance of the apparatus for controlling driving of a vehicle by more accurately and safely controlling the autonomous driving of the apparatus for controlling driving of a vehicle using the artificial intelligence and/or the machine learning algorithm.

An apparatus for controlling driving of a vehicle, comprising may include: an approaching vehicle tracker configured to check approaching vehicles located in a predetermined distance with respect to a host vehicle; an acquirer configured to acquire at least one of driving environment information including vehicle information of the host vehicle and road traffic information, vehicle information of a preceding vehicle located in front of the host vehicle among the approaching vehicles, and vehicle information of a following vehicle located behind the host vehicle; and an adaptive driving controller configured to control the host vehicle in an adaptive cruise mode so that a distance between the host vehicle and the preceding vehicle or the following vehicle is maintained within a predetermined distance based on the driving environment information of the host vehicle and the vehicle information of the preceding vehicle or the following vehicle and control the host vehicle in an adaptive avoidance mode when the set distance between the host vehicle and the preceding vehicle or the distance between the host vehicle and the following vehicle is not maintained within the predetermined distance.

According to the apparatus for controlling driving of a vehicle in accordance with the aspect of the present disclosure, it is possible to control the host vehicle to drive while maintaining the adaptive distance from other vehicles in response to the real-time change in space by recognizing the real-time change in space based on the approaching vehicles and the driving environment information around the host vehicle to thereby improve the safety and reliability of the apparatus for controlling driving of a vehicle.

The acquirer may receive the driving environment information of the host vehicle and the vehicle information of the preceding vehicle and the following vehicle based on a downlink grant of a 5G network connected to operate the host vehicle equipped with the apparatus for controlling driving of a vehicle in an autonomous driving mode, and at least a part of the driving environment information of the host vehicle may be received from an intelligent transport system (ITS) server connected to the 5G network.

According to the acquirer in accordance with the aspect of the present disclosure, it is possible to quickly collect data for the adaptive driving control by performing the vehicle-to-vehicle communication, the communication with the server, the communication with infrastructure through the 5G network-based V2X communication to receive the vehicle information and the driving environment information to thereby improve the performance of products.

The apparatus may further include: a TTC calculator configured to calculate at least one of a time to collision (TTC) calculated based on the vehicle information of the preceding vehicle and the distance between the host vehicle and the preceding vehicle and a time to collision calculated based on the vehicle information of the following vehicle and the distance between the host vehicle and the following vehicle; and a collision determiner configured to determine that at least one of the preceding vehicle and the following vehicle is located in a collision reserve section based on the time to collision or determine that at least one of the preceding vehicle and the following vehicle is located in a collision danger section.

According to the apparatus for controlling driving of a vehicle in accordance with the aspect of the present disclosure, it is possible to improve the accuracy and performance of the apparatus for controlling driving of a vehicle by calculating the collision possibility in consideration of the driving patterns of the approaching vehicles to perform the adaptive avoidance driving control.

The adaptive driving controller may warn the preceding vehicle when the preceding vehicle is located in the collision reserve section and a speed of the preceding vehicle is equal to or smaller than a threshold value, decelerate the host vehicle corresponding to the speed of the preceding vehicle when the preceding vehicle is located in the collision reserve section and the following vehicle is located in a section other than the collision reserve section and the collision danger section, warn the following vehicle when the preceding vehicle is located in the collision reserve section and the following vehicle is located in the collision reserve section; and determines whether the host vehicle performs a lane change when the preceding vehicle is located in the collision reserve section and the following vehicle is located in the collision danger section.

The adaptive driving controller may warn the preceding vehicle when the preceding vehicle is located in the collision danger section and a speed of the preceding vehicle is equal to or smaller than a threshold value, decelerate the host vehicle corresponding to the speed of the preceding vehicle when the preceding vehicle is located in the collision danger section and the following vehicle is located in a section other than the collision reserve section and the collision danger section, and warn the following vehicle and determining whether the host vehicle performs a lane change when the preceding vehicle is located in the collision danger section and the following vehicle is located in the collision reserve section or the collision danger section.

The adaptive driving controller may accelerate the host vehicle corresponding to the speed of the following vehicle when the following vehicle is located in the collision reserve section and the preceding vehicle is located in a section other than the collision reserve section and the collision danger section, warn the following vehicle when the following vehicle is located in the collision reserve section and the preceding vehicle is located in the collision reserve section, and determine whether the host vehicle performs a lane change when the following vehicle is located in the collision reserve section and the preceding vehicle is located in the collision danger section.

The adaptive driving controller may accelerate the host vehicle corresponding to the speed of the following vehicle when the following vehicle is located in the collision danger section and the preceding vehicle is located in a section other than the collision reserve section and the collision danger section, and warn the following vehicle and determining whether the host vehicle performs a lane change when the following vehicle is located in the collision danger section and the following vehicle is located in the collision reserve section or the collision danger section

According to the adaptive driving controller in accordance with the aspect of the present disclosure, it is possible to appropriately cope with various situations by applying the adaptive cruise mode and the adaptive avoidance mode according to a scenario while both the preceding vehicle and the following vehicle are driving in close proximity to each other and improve the user satisfaction by outputting the warning alarm to the preceding vehicle and the following vehicle to enable the quick response.

The apparatus may further include: a lane change determiner configured to determine whether a lane exist on left and right sides of the host vehicle and a vehicle exists behind the left and right sides of the host vehicle, set a movable lane of the host vehicle and a movable space of the movable lane, and calculate a time to collision based on the vehicle information of the following vehicle of the movable lane, and a distance between a reference point of the movable space and the following vehicle, in which the adaptive driving controller may perform the lane change of the host vehicle to the lane when the time to collision increases.

The apparatus may further include: an approaching vehicle tracker configured to acquire and track the vehicle information of the approaching vehicle for a predetermined time, acquire road traffic information from an ITS server for the predetermined time, and analyze a driving pattern of the approaching vehicle based on the tracking information and the road traffic information of the approaching vehicle for the predetermined time.

According to the lane change determiner, the adaptive driving controller, and the approaching vehicle tracker in accordance with the aspect of the present disclosure, it is possible to reduce the possibility of accidents and improve the reliability of products by performing the adaptive avoidance driving in consideration of the information on the approaching vehicles tracked for a predetermined time.

The apparatus may further include: an inputter configured to receive, as an input data, the vehicle information of the host vehicle, road traffic information from an ITS server, and vehicle information of the approaching vehicle located within the predetermined distance with respect to the host vehicle; a learning processor configured to apply the received input data to a learning model to extract an adaptive driving data of the host vehicle in response to a change in space around the host vehicle; and an outputter configured to output the adaptive driving data in response to the change in space around the host vehicle from the learning model, in which the learning model may be learned to generate the adaptive driving data according to the adaptive cruise mode or the adaptive avoidance mode based on the pre-calculated change state in space around the host vehicle and the plurality of pre-input data to correspond to the vehicle information of the host vehicle and the road traffic information and vehicle information data of the approaching vehicle, respectively, which are input in advance to recognize the change in space around the host vehicle.

According to the apparatus for controlling driving of a vehicle in accordance with the aspect of the present disclosure, it is possible to improve the performance of the apparatus for controlling driving of a vehicle by more accurately and safely controlling the autonomous driving of the apparatus for controlling driving of a vehicle using the artificial intelligence and/or the machine learning algorithm.

In addition, there may be further provided another method and another system for implementing the present disclosure and a computer-readable recording medium in which a computer program for executing the method is stored.

The above-mentioned aspects, features, and advantages and other aspects, features, and advantages will become obvious from the following drawings, claims, and detailed description of the present disclosure.

According to the embodiment of the present disclosure, it is possible to control the host vehicle to drive while maintaining the adaptive distance from other vehicles in response to the real-time change in space by recognizing the real-time change in space based on the approaching vehicles and the driving environment information around the host vehicle to thereby improve the safety and reliability of the apparatus for controlling driving of a vehicle.

In addition, it is possible to improve the accuracy and performance of the apparatus for controlling driving of a vehicle by calculating the collision probability in consideration of the driving patterns of the approaching vehicles to enable the adaptive avoidance driving control.

Further, it is possible to appropriately cope with various situations by applying the adaptive cruise mode and the adaptive avoidance mode according to a scenario while both the preceding vehicle and the following vehicle are driving in close proximity to each other.

Moreover, it is possible to improve the user satisfaction by outputting the warning alarm to the preceding vehicle and the following vehicle to enable the quick response.

In addition, it is possible to reduce the possibility of accidents and improve the reliability of products by performing the adaptive avoidance driving in consideration of the information on the approaching vehicle tracked for a predetermined time.

In addition, it is possible to improve the performance of the apparatus for controlling driving of a vehicle by more accurately and safely controlling the autonomous driving of the apparatus for controlling driving of a vehicle using the artificial intelligence and/or the machine learning algorithm.

In addition, it is possible to quickly collect data for the adaptive driving control by performing the vehicle-to-vehicle communication, the communication with the server, the communication with infrastructure through the 5G network-based V2X communication to receive the vehicle information and the driving environment information to thereby improve the performance of products.

In addition, although the apparatus for controlling driving of a vehicle is a uniform product that is mass-produced, the user recognizes the apparatus for controlling driving of a vehicle as a personalized device, so that the apparatus for controlling driving of a vehicle can exhibit the effect of the customized product.

The effects of the present disclosure are not limited to those mentioned above, and other effects not mentioned can be clearly understood by those skilled in the art from the following description.

### BRIEF DESCRIPTION OF THE DRAWINGS

FIG. 1 is an exemplary diagram of an AI system-based vehicle driving control environment that includes an AI server, a self-driving vehicle, a robot, an XR device, a smartphone or a home appliance, and a cloud network connecting at least one of them to each other according to an embodiment of the present disclosure.

FIG. 2 is a diagram for schematically describing a communication environment of an apparatus for controlling driving of a vehicle according to an embodiment of the present disclosure.

FIG. 3 is a schematic block diagram of the apparatus for controlling driving of a vehicle according to the embodiment of the present disclosure.

FIG. 4 is a diagram illustrating an example of basic operations of a self-driving vehicle and a 5G network in a 5G communication system.

FIG. 5 is a diagram illustrating an example of application operations of the self-driving vehicle and the 5G network in the 5G communication system.

FIGS. 6 to 9 are diagrams illustrating an example of an operation of a self-driving vehicle using 5G communication.

FIG. 10 is a schematic block diagram of a processor of the apparatus for controlling driving of a vehicle according to the embodiment of the present disclosure of FIG. 3.

FIGS. 11A to 11C are exemplary diagrams for describing an adaptive cruise mode of the apparatus for controlling driving of a vehicle according to the embodiment of the present disclosure when both a preceding vehicle and a following vehicle are not present or only one of the preceding vehicle and the following vehicle is present.

FIG. 12 is an exemplary diagram for describing an adaptive cruise mode of the apparatus for controlling driving of a vehicle according to the embodiment of the present disclosure between a preceding vehicle and a following vehicle.

FIGS. 13A and 13B are exemplary diagrams for describing an adaptive avoidance mode of the apparatus for controlling driving of a vehicle according to the embodiment of the present disclosure.

FIG. 14 is a schematic block diagram of a learner of the apparatus for controlling driving of a vehicle according to the embodiment of the present disclosure of FIG. 3.

FIG. 15 is a flowchart illustrating a method for controlling driving of a vehicle according to an embodiment of the present disclosure.

FIGS. 16 to 19 are flowcharts illustrating a method for controlling an adaptive avoidance mode of an apparatus for controlling driving of a vehicle according to an embodiment of the present disclosure.

FIG. 20 is a flowchart for describing a method for determining a lane change of the apparatus for controlling driving of a vehicle according to an embodiment of the present disclosure.

### DETAILED DESCRIPTION

Advantages and features of the present disclosure and methods for achieving them will become apparent from the descriptions of aspects hereinbelow with reference to the accompanying drawings. However, the description of particular example embodiments is not intended to limit the present disclosure to the particular example embodiments disclosed herein, but on the contrary, it should be understood that the present disclosure is to cover all modifications, equivalents and alternatives falling within the spirit and scope of the present disclosure. The example embodiments disclosed below are provided so that the present disclosure will be thorough and complete, and also to provide a more complete understanding of the scope of the present disclosure to those of ordinary skill in the art. In the interest of clarity, not all details of the relevant art are described in detail in the present specification in so much as such details are not necessary to obtain a complete understanding of the present disclosure.

The terminology used herein is used for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. Furthermore, these terms such as “first,” “second,” and other numerical terms, are used only to distinguish one element from another element. These terms are generally only used to distinguish one element from another.

A vehicle described in the present specification may refer to a car, an automobile, and a motorcycle. Hereinafter, the vehicle will be exemplified as an automobile.

The vehicle described in the present specification may include, but is not limited to, a vehicle having an internal combustion engine as a power source, a hybrid vehicle having an engine and an electric motor as a power source, and an electric vehicle having an electric motor as a power source.

In the following description, a left side of a vehicle means a left side of a driving direction of a vehicle, and a right side of a vehicle means a right side of a driving direction of a vehicle.

Hereinafter, embodiments of the present disclosure will be described in detail with reference to the accompanying drawings. Like reference numerals designate like elements throughout the specification, and overlapping descriptions of the elements will not be provided.

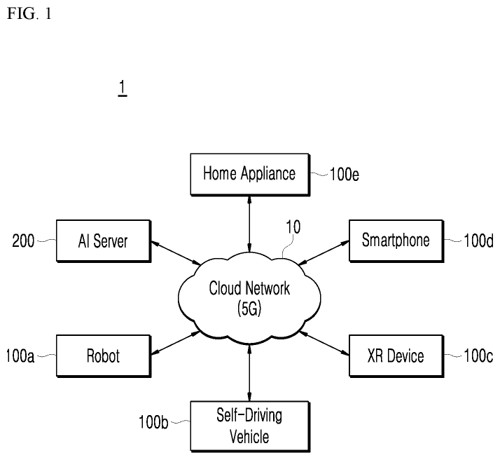

FIG. 1 is an exemplary diagram of AI system-based vehicle driving control environment that includes an AI server, a self-driving vehicle, a robot, an XR device, a smartphone or a home appliance, and a cloud network connecting at least one of them to each other according to an embodiment of the present disclosure.

Referring to FIG. 1, an AI system-based vehicle driving control environment 1 may include a robot 100a, a self-driving vehicle 100b, an XR device 100c, and a smartphone 100, or a home appliance 100e, an AI server 200, and a cloud network 10. In the AI system-based vehicle driving control environment 1, at least one of the AI server 200, the robot 100a, the self-driving vehicle 100b, the XR device 100c, the smartphone 100d, or the home appliance 100e may be connected to the cloud network 10. Here, the robot 100a, autonomous vehicle 100b, XR device 100c, smartphone 100d, or home appliance 100e to which the AI technology has been applied may be referred to as an AI device (100a to 100e).

In this case, the robot 100a may refer to a machine which automatically handles a given task by its own ability, or which operates autonomously. In particular, a robot having a function of recognizing an environment and performing an operation according to its own judgment may be referred to as an intelligent robot. The robot 100a may be classified into industrial, medical, household, and military robots, according to the purpose or field of use. The robot 100a may include an actuator or a driving unit including a motor in order to perform various physical operations, such as moving joints of the robot. Moreover, a movable robot may include, for example, a wheel, a brake, and a propeller in the driving unit thereof, and through the driving unit may thus be capable of traveling on the ground or flying in the air.

The self-driving vehicle 100b may mean a vehicle which drives without a manipulation of a user or with a minimal manipulation of a user, and may also be referred to as an autonomous-driving vehicle. For example, autonomous driving may include a technology in which a driving lane is maintained, a technology such as adaptive cruise control in which a speed is automatically adjusted, a technology in which a vehicle automatically drives along a defined route, and a technology in which a route is automatically set when a destination is set. In this case, an autonomous vehicle may be considered as a robot with an autonomous driving function.

The XR device 100c refers to a device using eXtended Reality (XR) which collectively refers to Virtual Reality (VR), Augmented Reality (AR), and Mixed Reality (MR). The VR technology provides objects or backgrounds of the real world only in the form of CG images, AR technology provides virtual CG images overlaid on the physical object images, and MR technology employs computer graphics technology to mix and merge virtual objects with the real world. MR technology is similar to AR technology in a sense that physical objects are displayed together with virtual objects. However, while virtual objects supplement physical objects in the AR, virtual and physical objects co-exist as equivalents in the MR. The XR technology may be applied to Head-Mounted Display (HMD), Head-Up Display (HUD), mobile phone, tablet PC, laptop computer, desktop computer, TV, digital signage, and so on, where a device employing the XR technology may be called an XR device.

The smartphone 100d may mean, for example, one of user terminals. Such a user terminal may access applications for operating an apparatus for controlling driving of a vehicle or a site for operating an apparatus for controlling driving of a vehicle and then receive services for operating or controlling an apparatus for controlling driving of a vehicle through an authentication process. In the present embodiment, the user terminal may operate the apparatus for controlling driving of a vehicle and control an operation of a host vehicle.

In this embodiment, the user terminal may be a desktop computer, a smart phone, a notebook computer, a tablet PC, a smart TV, a mobile phone, a personal digital assistant (PDA), a laptop, a media player, a micro server, a global positioning system (GPS) device, an electronic book terminal, a digital broadcast terminal, a navigation system, a kiosk, an MP3 player, a digital camera, a home appliance, and any other mobile or non-mobile computing device, but the present disclosure is not limited to these examples. Further, the user terminal may be a wearable terminal such as a clock, eyeglasses, a hair band, and a ring having a communication function and a data processing function. The user terminal is not limited to the above-mentioned devices, and thus any terminal that supports web browsing may be adopted.

The home appliance 100e may include any one of all electronic devices provided in the home, and may include, in particular, a terminal capable of implementing voice recognition, artificial intelligence, and the like, and a terminal for outputting one or more of an audio signal and a video signal. In addition, the home appliance 100e may include various home appliances (for example, a washing machine, a dryer, a clothes processing apparatus, an air conditioner, a kimchi refrigerator, and the like) without being limited to a specific electronic device.

The cloud network 10 may comprise part of the cloud computing infrastructure or refer to a network existing in the cloud computing infrastructure. Here, the cloud network 10 may be constructed by using the 3G network, 4G or Long Term Evolution (LTE) network, or 5G network. That is, each of the devices 100a to 100e and 200 constituting the AI system-based vehicle driving control environment 1 may be connected to each other through the cloud network 10. In particular, each individual device (100a to 100e, 200) may communicate with each other through the base station but may communicate directly to each other without relying on the base station.

The cloud network 10 may include, for example, wired networks such as local area networks (LANs), wide area networks (WANs), metropolitan area networks (MANs), and integrated service digital networks (ISDNs), or wireless networks such as wireless LANs, CDMA, Bluetooth, and satellite communication, but the scope of the present disclosure is not limited thereto. Furthermore, the cloud network 10 may transmit and receive information using short-range communications or long-distance communications. Here, the short-range communications may include Bluetooth, radio frequency identification (RFID), infrared data association (IrDA), ultra-wideband (UWB), ZigBee, and wireless fidelity (Wi-Fi) technology, and the long-distance communications may include code division multiple access (CDMA), frequency division multiple access (FDMA), time division multiple access (TDMA), orthogonal frequency division multiple access (OFDMA), and single carrier frequency division multiple access (SC-FDMA) technology.

The cloud network 10 may include connection of network elements such as hubs, bridges, routers, switches, and gateways. The cloud network 10 may include one or more connected networks, including a public network such as the Internet and a private network such as a secure corporate private network.

For example, the network may include a multi-network environment. The access to the cloud network 10 can be provided via one or more wired or wireless access networks. Furthermore, the cloud network 10 may support the Internet of things (IoT) for exchanging and processing information between distributed elements such as things or the like and/or 5G communication.

The AI server 200 may include a server performing AI processing and a server performing computations on big data. In addition, the AI server 200 may be a database server that provides big data necessary for applying various artificial intelligence algorithms and data for operating the apparatus for controlling driving of a vehicle. In addition, the AI server 200 may include a web server or an application server which can remotely control the operation of the host vehicle by using the applications for operating the apparatus for controlling driving of a vehicle or the web browser for operating the apparatus for controlling driving of a vehicle which are installed in the smartphone 100d.

The AI server 200 is connected to at least one of the robot 100a, the self-driving vehicle 100b, the XR device 100c, the smartphone 100d, or the home appliance 100e, which are the AI devices constituting the AI system-based vehicle driving control environment 1 through the cloud network 10, and assist at least a part of AI processing of the connected AI devices 100a to 100e. At this time, the AI server 200 may teach the artificial neural network according to a machine learning algorithm on behalf of the AI device (100a to 100e), directly store the learning model, or transmit the learning model to the AI device (100a to 100e). At this time, the AI server 200 may receive input data from the AI device 100a to 100e, infer a result value from the received input data by using the learning model, generate a response or control command based on the inferred result value, and transmit the generated response or control command to the AI device 100a to 100e. Similarly, the AI device 100a to 100e may infer a result value from the input data by employing the learning model directly and generate a response or control command based on the inferred result value.

Here, the artificial intelligence (AI), which is an area of computer engineering and information technology for studying methods for enabling computers to mimic thinking, learning, self-development, or the like that can be carried out with human intelligence, may represent enabling computers to mimic human intelligent behavior.

In addition, artificial intelligence (AI) does not exist on its own, but is rather directly or indirectly related to a number of other fields in computer science. In recent years, there have been numerous attempts to introduce an element of AI into various fields of information technology to solve problems in the respective fields.

Machine learning is an area of artificial intelligence that includes the field of study that gives computers the capability to learn without being explicitly programmed. More specifically, machine learning is a technology that investigates and builds systems, and algorithms for such systems, which are capable of learning, making predictions, and enhancing their own performance on the basis of experiential data. Machine learning algorithms, rather than only executing rigidly-set static program commands, may be used to take an approach that builds models for deriving predictions and decisions from inputted data.

The present embodiment particularly relates to the self-driving vehicle 100b. Hereinafter, the embodiment of the self-driving vehicle 100b among the AI devices to which the above-described technology is applied will be described.

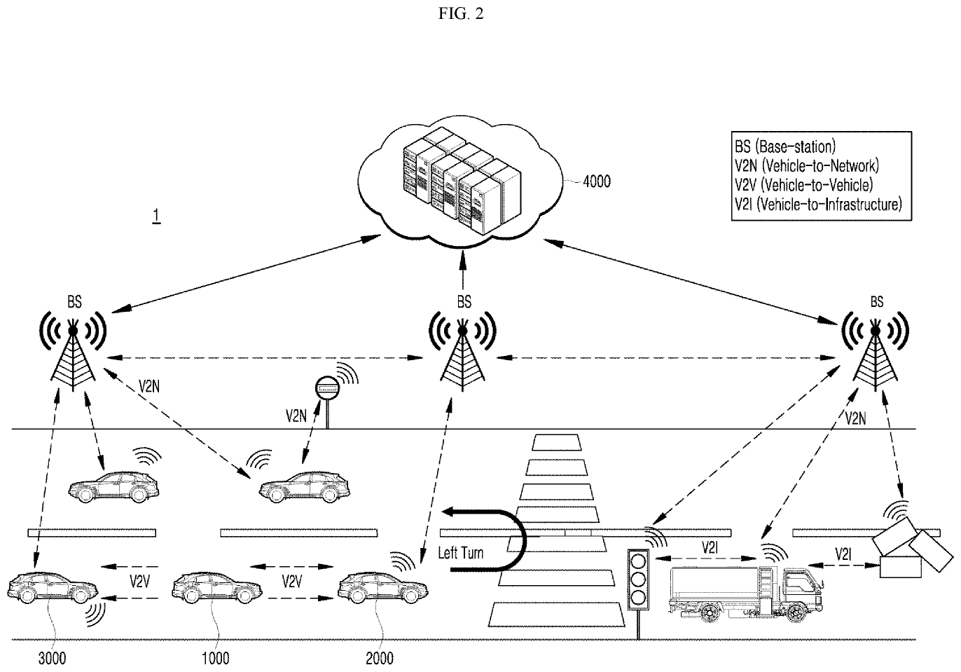

FIG. 2 is a diagram for schematically describing a communication environment of an apparatus for controlling driving of a vehicle according to an embodiment of the present disclosure. Hereinbelow, the common parts previously described with reference to FIG. 1 will not be described, so as to avoid repetitive description.

Referring to FIG. 2, the AI system-based vehicle driving control environment 1 may essentially include a host vehicle 1000, a preceding vehicle 2000 driving in front of a predetermined distance from the host vehicle 1000, a following vehicle 3000 driving behind a predetermined distance from the host vehicle 1000, and a server 4000, and may include a plurality of road side units (RSUs) including infrastructures such as vehicles driving on a road, a road sign, and a traffic light, a network base station (BS), and the like.

In this case, the server 4000 may serve as a general server, and may be connected to a base station (BS) next to a road within a radio access network (RAN) to provide flexible vehicle-related services and effectively operate a network. In particular, network-slicing and traffic scheduling policies supported by the server 4000 may help to optimize the network. In the present embodiment, the server 4000 may include the above-described AI server, a mobile edge computing (MEC) server, an intelligent transport system (ITS) server that provides road traffic information, and the like, and may collectively refer to these components. However, in the present embodiment, the server 4000 illustrated in FIG. 2 may represent an ITS server. However, the server 4000 may represent the AI server, the MEC server, and the like. In this case, the connection relationship and the like illustrated in FIG. 2 may vary.

The MEC server may serve as a general server, and may be connected to the base station (BS) next to a road within the radio access network (RAN) to provide the flexible vehicle-related services and effectively operate the network. In particular, the network-slicing and traffic scheduling policies supported by the MEC server may help to optimize the network. The MEC server may be integrated in the RAN and may be located in an S1-user plane interface (for example, between the core network and the base station) in the 3GPP system. Each MEC server can be considered as an independent network element, and does not affect the connection of the existing wireless networks. The independent MEC server may be connected to the base station via a dedicated communication network and may provide specific services to various end-users located in the cell. These MEC servers and the cloud servers may be connected to each other and may share information through an internet-backbone. In addition, the MEC server may be operated independently and may control a plurality of base stations. In particular, the MEC server may perform application operations such as services for a self-driving vehicle, application operations such as a virtual machine (VM), and operations at an edge end of a mobile network based on a virtualization platform. The base station (BS) may be connected to both the MEC servers and the core network to enable flexible user traffic scheduling required for performing the services provided. When a large-capacity user traffic occurs in a specific cell, the MEC server may perform task offloading and collaborative processing based on an interface between adjacent base stations. That is, since the MEC server has an open operating environment based on software, new services of an application provider can be easily provided. In addition, since the MEC server performs services near the end-user, a data round-trip time is shortened and a service providing speed is fast, thereby reducing a service waiting time. In addition, MEC applications and virtual network functions (VNFs) may provide flexibility and geographic distribution in service environments. By using this virtualization technology, various applications and network functions may be not only programmed, but also only specific groups of users may be selected or a compile for the selected groups can be performed. Therefore, the services provided can be applied more closely to user requirements. In addition to centralized control ability, the MEC server can minimize an interaction between the base stations. This may simplify a process for performing basic functions of a network, such as handover between cells. These functions can be particularly useful in an autonomous driving system with many users. In addition, in the autonomous driving system, terminals of a road may periodically generate a large amount of small packets. In the RAN, the MEC server may reduce the amount of traffic that should be delivered to the core network by performing specific services, thereby reducing a processing burden on a cloud in a centralized cloud system and minimizing a network congestion. The MEC server also integrates the network control functions and individual services to increase profitability of mobile network operators (MNOs) and adjusts an installation density to enable faster and more efficient maintenance and upgrade.

The ITS server, which is a server for collecting, processing, and propagating comprehensive traffic information, may mean a server which collects, processes, and works traffic-related information, weather information, road conditions, and the like, for roads, vehicles, drivers, and travelers all over the country to transmit the information to vehicle drivers and travelers using roadside traffic terminals, in-vehicle terminals, traffic broadcasting, PC communications, telephones, and the like through wired/wireless communication means to thereby achieve convenience of traffic and smooth flow of traffic. That is, in the present embodiment, vehicles, that is, the host vehicle 1000, the preceding vehicle 2000, and the following vehicle 3000 may receive traffic information from the ITS server. In particular, the host vehicle 1000 may receive driving environment information (driving road information, driving traffic information, surrounding vehicle information, driving weather information, and the like) which is part of the vehicle information of the host vehicle 1000 from the ITS server.

Meanwhile, in the present embodiment, as illustrated in FIG. 2, the host vehicle may communicate with a vehicle, an RSU, an ITS server, a pedestrian, or the like may be communicated through vehicle to everything (V2X) communication. The V2X communication may transmit and receive signals to and from a radio side unit (RSU) (V2I: vehicle to infrastructure), another vehicle (V2V: vehicle to vehicle), a ITS server (V2N: vehicle to network), or a user terminal (V2P: vehicle to pedestrian) in a wireless manner. In addition, the V2X communication may perform a V2P communication function for transmitting and receiving signals through one of a PC5 interface and an LTE-Uu interface.

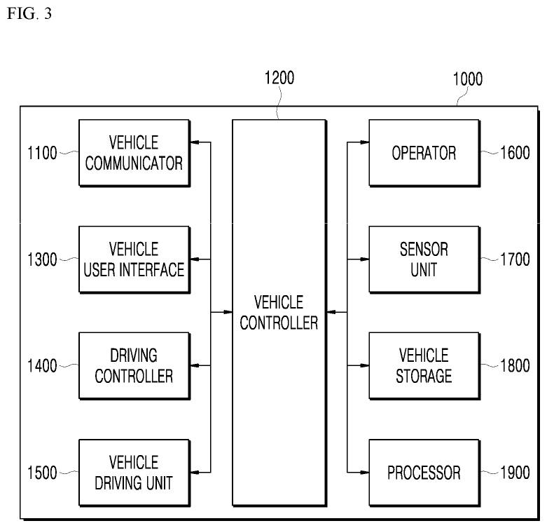

In particular, in the present embodiment, the host vehicle may be connected to the intelligent transport system (ITS) server providing road traffic information to transmit and receive signals through one of a vehicle to infrastructure (V2I) protocol and a vehicle to network (V2N) protocol. That is, in the present embodiment, the host vehicle may provide the information and data obtained to a traffic system, and receive a control signal from the traffic system and provided to the received control signal to a vehicle controller (1200 of FIG. 3).

That is, in the present embodiment, the host vehicle 1000 may recognize the real-time change in space through the V2X communication to maintain an adaptive distance between the preceding vehicle 2000 and the following vehicle 3000, and may warn the preceding vehicle 2000 and the following vehicle 3000 when the adaptive distance cannot be maintained or enable adaptive avoidance based on surrounding situations. In this case, since the driving pattern is different for each vehicle, in the present embodiment, the host vehicle may estimate the driving patterns of the preceding vehicle 2000 and the following vehicle 3000 by receiving information on the surrounding situations from the vehicle, the infrastructure, the ITS server, and the like through the V2X communication for the adaptive distance maintenance and the adaptive avoidance. For example, in the present embodiment, the host vehicle may estimate the driving pattern based on a change in state (change in movement such as speed, acceleration, deceleration, direction change, and the like) of approaching vehicles while tracking the approaching vehicles (front/back/left/right), signals (signals such as headlight, klaxon, and the like), and surrounding environment (light amount, sun position, weather, and the like).

FIG. 3 is a schematic block diagram of the apparatus for controlling driving of a vehicle according to the embodiment of the present disclosure. In the following description, the description of the overlapping portions with the description of FIGS. 1 and 2 will be omitted.

Referring to FIG. 3, the apparatus for controlling driving of a vehicle mounted in a vehicle, that is, the host vehicle 1000 may include a vehicle communicator 1100, a vehicle controller 1200, a vehicle user interface 1300, and a driving controller 1400, a vehicle driving unit 1500, an operator 1600, a sensor unit 1700, a vehicle storage 1800, and a processor 1900.

According to the embodiment, the apparatus for controlling driving of a vehicle may include other components in addition to the components illustrated in FIG. 3 and described below, or may not include some of the components illustrated in FIG. 3 and described below.

In the present embodiment, the apparatus for controlling driving of a vehicle may be mounted in the host vehicle 1000 that includes a wheel rotating by a power source and a steering input device for adjusting a driving direction. Here, the host vehicle 1000 may be a self-driving vehicle and may be switched from an autonomous driving mode to a manual mode or from the manual mode to the autonomous driving mode according to a user input received through the vehicle user interface 1300. In addition, the host vehicle 1000 may be switched from the autonomous driving mode to the manual mode or from the manual mode to the autonomous driving mode according to the driving situations. Here, the driving situations may be determined by at least one of information received by the vehicle communicator 1100, external object information detected by the sensor unit 1700, and navigation information acquired by the navigator (not shown).

Meanwhile, in the present embodiment, the host vehicle 1000 may receive a service request (user input) from a user for control. As the method for receiving, by a host vehicle 1000, a service providing request from a user, there may be a method for receiving a spoken voice corresponding to a service request from a user at the time of receiving a touch (or button input) signal for a vehicle user interface 1300 from the user and the like. In this case, the reception of the touch signal, the reception of the spoken voice, and the like from the user may be possible by the smartphone (100d of FIG. 1). In addition, for the reception of the spoken voice, a separate microphone may be provided to execute a voice recognition function.

When the host vehicle 1000 operates in the autonomous driving mode, the host vehicle 1000 may operate under the control of the operator 1600 that controls driving, unparking, and parking operations. Meanwhile, when the host vehicle 1000 operates in the manual mode, the host vehicle 1000 may operate by an input through the driving controller 1400 of the driver.

The vehicle communicator 1100 may be a module for performing communication with an external device. The vehicle communicator 1100 may support communication by a plurality of communication modes, receive a server signal from a server (4000 of FIG. 2), and transmit a signal to the server. In addition, the vehicle communicator 1100 may receive a signal from another vehicle, transmit a signal to another vehicle, receive a signal from a smartphone, and transmit a signal to the smartphone. That is, the external device may include another vehicle, a smartphone, and a server system. Also, the plurality of communication modes may include a vehicle-to-vehicle communication mode for performing communication with another vehicle, a server communication mode for performing communication with an ITS server, and the like. That is, the vehicle communicator 1100 may include a wireless communicator (not shown), a V2X communicator (not shown), an ITS communicator (not shown), and the like. In addition, the vehicle communicator 1100 may include a location information unit for receiving a signal including location information of the host vehicle 1000. The location information unit may include a global positioning system (GPS) module or a differential global positioning system (DGPS) module.

The wireless communicator may transmit and receive signals to and from a smartphone or a server through a mobile communication network. Here, the mobile communication network is a multiple access system capable of supporting communication of multiple users by sharing used system resources (bandwidth, transmission power, and the like). Examples of the multiple access system include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system, a multi carrier frequency division multiple access (MC-FDMA) system, and the like. In addition, the wireless communicator may transmit specific information to the 5G network when the host vehicle 1000 operates in the autonomous driving mode. The specific information may include autonomous driving related information. The autonomous driving related information may be information directly related to the running control of the vehicle. For example, the autonomous driving related information may include at least one of object data indicating an object around the vehicle, map data, vehicle state data, vehicle position data, and driving plan data. The autonomous driving related information may further include service information necessary for autonomous driving. For example, the specific information may include information about the destination and the stability level of the vehicle, which are inputted through the smartphone. In addition, the 5G network may determine whether a vehicle is to be remotely controlled. Here, the 5G network may include a server or a module that performs autonomous driving related remote control. The 5G network may transmit information (or a signal) related to the remote control to an autonomous driving vehicle. As described above, the information related to the remote control may be a signal directly applied to the autonomous vehicle, and may further include service information required for autonomous driving.

The V2X communicator may transmit and receive signals to and from the RSU through the V2I communication protocol in a wireless manner, transmit and receive signals to another vehicle, that is, a vehicle within a predetermined distance from the host vehicle 1000 through the V2V communication protocol, and transmit and receive signals to and from a smartphone, that is, a pedestrian or a user through the V2P communication protocol. That is, the V2X communicator may include an RF circuit capable of implementing communication with infrastructure (V2I), vehicle-to-vehicle communication (V2V), and communication with a smartphone (V2P) protocols. The intelligent transport system (ITS) communicator may be connected to the intelligent transport system (ITS) server providing road traffic information to transmit and receive signals through one of the vehicle to infrastructure (V2I) protocol and the vehicle to network (V2N) protocol. The ITS communicator may provide information and data such as road traffic information, driving road information, road regulation speed, and the like. That is, for example, the ITS communicator may receive road traffic information from the traffic system and provide the received road traffic information to the vehicle controller 1200, and receive a control signal from the traffic system and provide the received control signal to the vehicle controller 1200 or a processor provided inside the host vehicle 1000.

That is, the vehicle communicator 1100 may include at least one among a transmission antenna, a reception antenna, a radio frequency (RF) circuit capable of implementing various communication protocols, and an RF element in order to perform communication. In addition, the vehicle communicator 1100 may perform short range communication, GPS signal reception, V2X communication, optical communication, broadcast transmission/reception, and intelligent transport systems (ITS) communication functions. The vehicle communicator 1100 may further support other functions than the functions described, or may not support some of the functions described, depending on the embodiment. The vehicle communicator 1100 may support short-range communication by using at least one among Bluetooth™, Radio Frequency Identification (RFID), Infrared Data Association (IrDA), Ultra WideBand (UWB), ZigBee, Near Field Communication (NFC), Wireless-Fidelity (Wi-Fi), Wi-Fi Direct, and Wireless Universal Serial Bus (Wireless USB) technologies.

Depending on the embodiment, the overall operation of each module of the vehicle communicator 1100 may be controlled by a separate process provided in the vehicle communicator 1100. The vehicle communicator 1100 may include a plurality of processors, or may not include a processor. When a processor is not included in the vehicle communicator 1100, the vehicle communicator 1100 may be operated by either a processor of another apparatus in the vehicle 1000 or the vehicle controller 1200. In addition, the vehicle communicator 1100 may, together with the vehicle user interface 1300, implement a vehicle-use display device. In this case, the vehicle display device may be referred to as a telematics device or an audio video navigation (AVN) device.

Meanwhile, in the present embodiment, the vehicle communicator 1100 may receive the driving environment information of the host vehicle 1000 and the vehicle information of the preceding vehicle 2000 and the following vehicle 3000 based on a downlink grant of a 5G network connected to operate the host vehicle 1000 equipped with the apparatus for controlling driving of a vehicle in the autonomous driving mode. In this case, the vehicle communicator 1100 may receive at least a part of the driving environment information of the vehicle from the intelligent transport system (ITS) server connected to the 5G network.

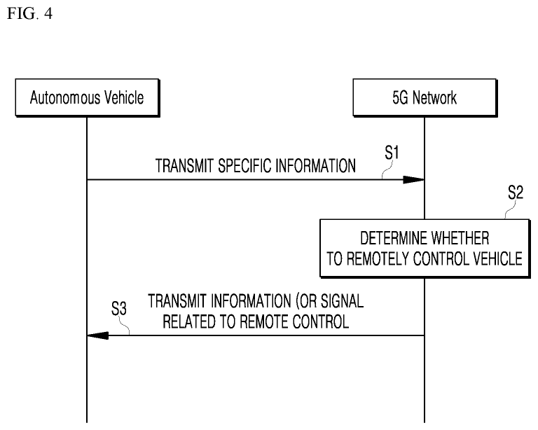

FIG. 4 is a diagram showing an example of the basic operation of an autonomous vehicle and a 5G network in a 5G communication system.

The vehicle communicator 1100 may transmit specific information over a 5G network when the vehicle 1000 is operated in the autonomous driving mode (S1).

The specific information may include autonomous driving related information.

The autonomous driving related information may be information directly related to the driving control of the vehicle. For example, the autonomous driving related information may include at least one among object data indicating an object near the vehicle, map data, vehicle status data, vehicle location data, and driving plan data.

The autonomous driving related information may further include service information necessary for autonomous driving. For example, the specific information may include information on a destination inputted through the user terminal 1300 and a safety rating of the vehicle.

In addition, the 5G network may determine whether the vehicle is remotely controlled (S2).

The 5G network may include a server or a module for performing remote control related to autonomous driving.

The 5G network may transmit information (or a signal) related to the remote control to an autonomous driving vehicle (S3).

As described above, information related to the remote control may be a signal directly applied to the autonomous driving vehicle, and may further include service information necessary for autonomous driving. The autonomous driving vehicle according to this embodiment may receive service information such as insurance for each interval selected on a driving route and risk interval information, through a server connected to the 5G network to provide services related to the autonomous driving.

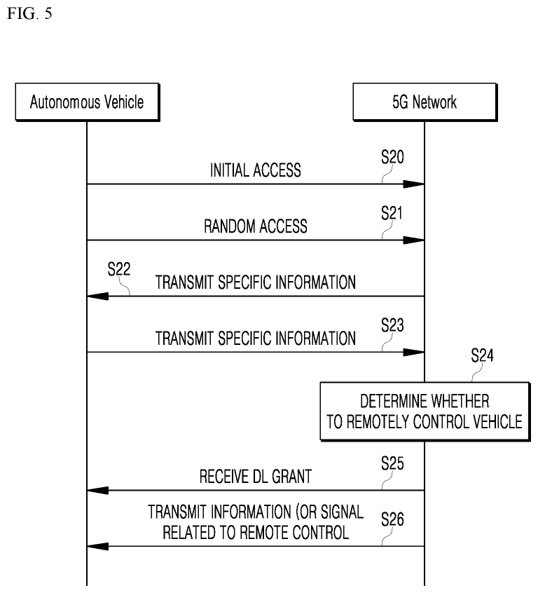

An essential process for performing 5G communication between the autonomous driving vehicle and the 5G network (for example, an initial access process between the vehicle 1000 and the 5G network) will be briefly described with reference to FIG. 5 to FIG. 9 below.

An example of application operations through the autonomous driving vehicle 1000 performed in the 5G communication system and the 5G network is as follows.

The vehicle 1000 may perform an initial access process with the 5G network (initial access step, S20). In this case, the initial access procedure includes a cell search process for acquiring downlink (DL) synchronization and a process for acquiring system information.

The vehicle 1000 may perform a random access process with the 5G network (random access step, S21). At this time, the random access procedure includes an uplink (UL) synchronization acquisition process or a preamble transmission process for UL data transmission, a random access response reception process, and the like.

The 5G network may transmit an Uplink (UL) grant for scheduling transmission of specific information to the autonomous driving vehicle 1000 (UL grant receiving step, S22).

The procedure by which the vehicle 1000 receives the UL grant includes a scheduling process in which a time/frequency resource is allocated for transmission of UL data to the 5G network.

The autonomous driving vehicle 1000 may transmit specific information over the 5G network based on the UL grant (specific information transmission step, S23).

The 5G network may determine whether the vehicle 1000 is to be remotely controlled based on the specific information transmitted from the vehicle 1000 (vehicle remote control determination step, S24).

The autonomous driving vehicle 1000 may receive the DL grant through a physical DL control channel for receiving a response on pre-transmitted specific information from the 5G network (DL grant receiving step, S25).

The 5G network may transmit information (or a signal) related to the remote control to the autonomous driving vehicle 1000 based on the DL grant (remote control related information transmission step, S26).

A process in which the initial access process and/or the random access process between the 5G network and the autonomous driving vehicle 1000 is combined with the DL grant receiving process has been exemplified. However, the present disclosure is not limited thereto.

For example, an initial access procedure and/or a random access procedure may be performed through an initial access step, an UL grant reception step, a specific information transmission step, a remote control decision step of the vehicle, and an information transmission step associated with remote control. Further, an initial access procedure and/or a random access procedure may be performed through a random access step, an UL grant reception step, a specific information transmission step, a remote control decision step of the vehicle, and an information transmission step associated with remote control. The autonomous driving vehicle 1000 may be controlled by the combination of an AI operation and the DL grant receiving process through the specific information transmission step, the vehicle remote control determination step, the DL grant receiving step, and the remote control related information transmission step.

The operation of the autonomous driving vehicle 1000 described above is merely exemplary, but the present disclosure is not limited thereto.

For example, the operation of the autonomous driving vehicle 1000 may be performed by selectively combining the initial access step, the random access step, the UL grant receiving step, or the DL grant receiving step with the specific information transmission step, or the remote control related information transmission step. The operation of the autonomous driving vehicle 1000 may include the random access step, the UL grant receiving step, the specific information transmission step, and the remote control related information transmission step. The operation of the autonomous driving vehicle 1000 may include the initial access step, the random access step, the specific information transmission step, and the remote control related information transmission step. The operation of the autonomous driving vehicle 1000 may include the UL grant receiving step, the specific information transmission step, the DL grant receiving step, and the remote control related information transmission step.

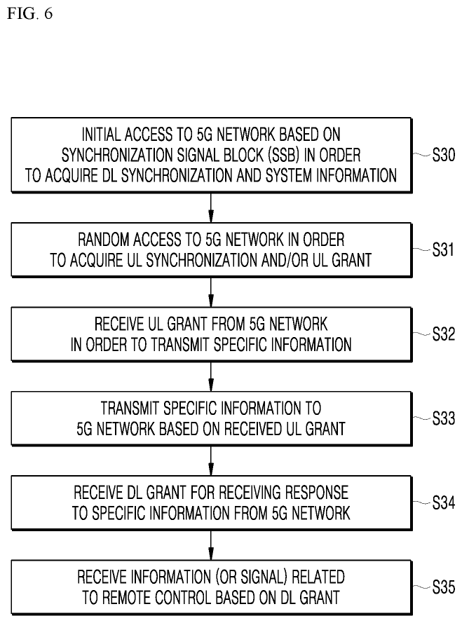

As illustrated in FIG. 6, the vehicle 1000 including an autonomous driving module may perform an initial access process with the 5G network based on Synchronization Signal Block (SSB) in order to acquire DL synchronization and system information (initial access step).

The autonomous driving vehicle 1000 may perform a random access process with the 5G network for UL synchronization acquisition and/or UL transmission (random access step, S31).

The autonomous driving vehicle 1000 may receive the UL grant from the 5G network for transmitting specific information (UL grant receiving step, S32).

The autonomous driving vehicle 1000 may transmit the specific information to the 5G network based on the UL grant (specific information transmission step, S33).

The autonomous driving vehicle 1000 may receive the DL grant from the 5G network for receiving a response to the specific information (DL grant receiving step, S34).

The autonomous driving vehicle 1000 may receive remote control related information (or a signal) from the 5G network based on the DL grant (remote control related information receiving step, S35).

A beam management (BM) process may be added to the initial access step, and a beam failure recovery process associated with Physical Random Access Channel (PRACH) transmission may be added to the random access step. QCL (Quasi Co-Located) relation may be added with respect to the beam reception direction of a Physical Downlink Control Channel (PDCCH) including the UL grant in the UL grant receiving step, and QCL relation may be added with respect to the beam transmission direction of the Physical Uplink Control Channel (PUCCH)/Physical Uplink Shared Channel (PUSCH) including specific information in the specific information transmission step. Further, a QCL relationship may be added to the DL grant reception step with respect to the beam receiving direction of the PDCCH including the DL grant.

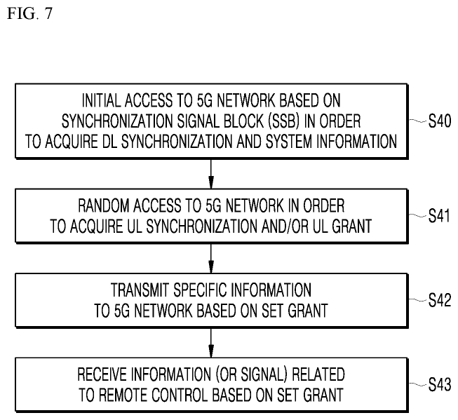

As illustrated in FIG. 7, the autonomous driving vehicle 1000 may perform an initial access process with the 5G network based on SSB for acquiring DL synchronization and system information (initial access step, S40).

The autonomous driving vehicle 1000 may perform a random access process with the 5G network for UL synchronization acquisition and/or UL transmission (random access step, S41).

The autonomous driving vehicle 1000 may transmit specific information based on a configured grant to the 5G network (UL grant receiving step, S42). In other words, instead of receiving the UL grant from the 5G network, the configured grant may be received.

The autonomous driving vehicle 1000 may receive the remote control related information (or a signal) from the 5G network based on the configured grant (remote control related information receiving step, S43).

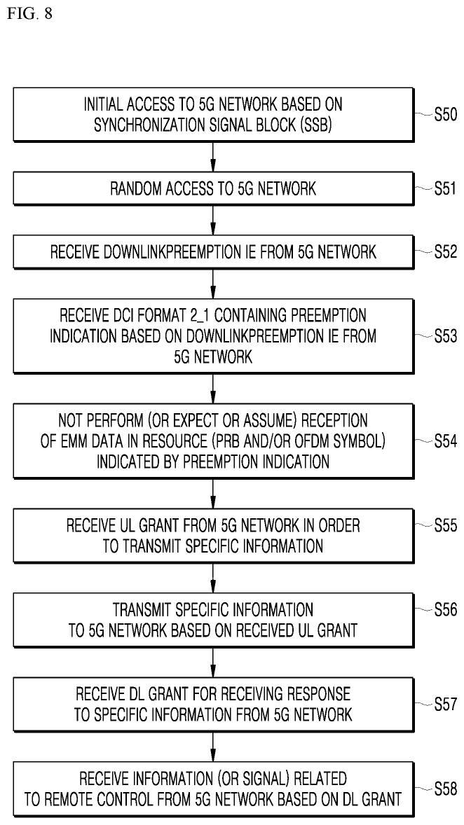

As illustrated in FIG. 8, the autonomous driving vehicle may perform an initial access process with the 5G network based on SSB for acquiring DL synchronization and system information (initial access step, S50).

The autonomous driving vehicle 1000 may perform a random access process with the 5G network for UL synchronization acquisition and/or UL transmission (random access step, S51).

In addition, the autonomous driving vehicle 1000 may receive Downlink Preemption (DL) and Information Element (IE) from the 5G network (DL Preemption IE reception step, S52).

The autonomous driving vehicle 1000 may receive DCI (Downlink Control Information) format 2_1 including preemption indication based on the DL preemption IE from the 5G network (DCI format 2_1 receiving step, S53).

The autonomous driving vehicle 1000 may not perform (or expect or assume) the reception of eMBB data in the resource (PRB and/or OFDM symbol) indicated by the pre-emption indication (step of not receiving eMBB data, S54).

The autonomous driving vehicle 1000 may receive the UL grant over the 5G network for transmitting specific information (UL grant receiving step, S55).

The autonomous driving vehicle 1000 may transmit the specific information to the 5G network based on the UL grant (specific information transmission step, S56).

The autonomous driving vehicle 1000 may receive the DL grant from the 5G network for receiving a response to the specific information (DL grant receiving step, S57).

The autonomous driving vehicle 1000 may receive the remote control related information (or signal) from the 5G network based on the DL grant (remote control related information receiving step, S58).

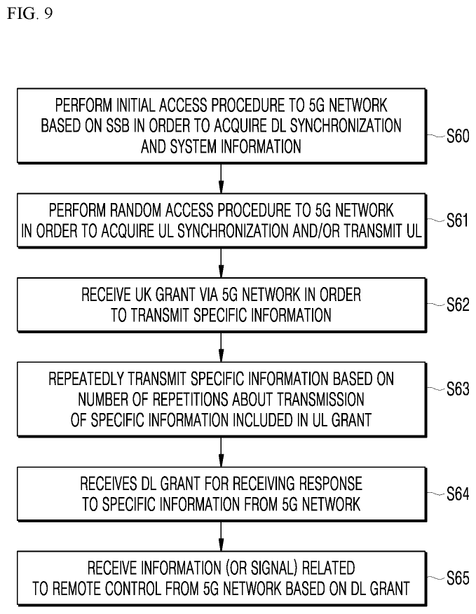

As illustrated in FIG. 9, the autonomous driving vehicle 1000 may perform an initial access process with the 5G network based on SSB for acquiring DL synchronization and system information (initial access step, S60).

The autonomous driving vehicle 1000 may perform a random access process with the 5G network for UL synchronization acquisition and/or UL transmission (random access step, S61).

The autonomous driving vehicle 1000 may receive the UL grant over the 5G network for transmitting specific information (UL grant receiving step, S62).

When specific information is transmitted repeatedly, the UL grant may include information on the number of repetitions, and the specific information may be repeatedly transmitted based on information on the number of repetitions (specific information repetition transmission step, S63).

The autonomous driving vehicle 1000 may transmit the specific information to the 5G network based on the UL grant.

Also, the repetitive transmission of specific information may be performed through frequency hopping, the first specific information may be transmitted in the first frequency resource, and the second specific information may be transmitted in the second frequency resource.

The specific information may be transmitted through Narrowband of Resource Block (6RB) and Resource Block (1RB).

The autonomous driving vehicle 1000 may receive the DL grant from the 5G network for receiving a response to the specific information (DL grant receiving step, S64).

The autonomous driving vehicle 1000 may receive the remote control related information (or signal) from the 5G network based on the DL grant (remote control related information receiving step, S65).

The above-described 5G communication technique can be applied in combination with the embodiment proposed in this specification, which will be described in FIG. 1 to FIG. 20, or supplemented to specify or clarify the technical feature of the embodiment proposed in this specification.

The vehicle 1000 may be connected to an external server through a communication network, and may be capable of moving along a predetermined route without a driver's intervention by using an autonomous driving technique. In the present embodiment, a user may be interpreted as a driver, a passenger, or an owner of a smartphone (user terminal).

The vehicle user interface 1300 may allow interaction between the vehicle 1000 and a vehicle user, receive an input signal of the user, transmit the received input signal to the vehicle controller 1200, and provide information included in the vehicle 1000 to the user under the control of the vehicle controller 1200. The vehicle user interface 1300 may include, but is not limited to, an input module, an internal camera, a bio-sensing module, and an output module.

The input module is for receiving information from a user.

The data collected by the input module may be analyzed by the vehicle controller 1200 and processed by the user's control command. The input module may receive the destination of the vehicle 1000 from the user and provide the destination to the controller 1200. The input module may input to the vehicle controller 1200 a signal for designating and deactivating at least one of the plurality of sensor modules of the sensor unit 1700 according to the user's input.

The input module may be disposed inside the vehicle. For example, the input module may be disposed on one area of a steering wheel, one area of an instrument panel, one area of a seat, one area of each pillar, one area of a door, one area of a center console, one area of a head lining, one area of a sun visor, one area of a windshield, or one area of a window.

The output module is for generating an output related to visual, auditory, or tactile information. The output module may output a sound or an image. Furthermore, the output module may include at least one of a display module, an acoustic output module, and a haptic output module.

The display module may display graphic objects corresponding to various information. The display module may include at least one of a liquid crystal display (LCD), a thin film transistor liquid crystal display (TFT LCD), an organic light emitting diode (OLED), a flexible display, a 3D display, or an e-ink display. The display module may form an interactive layer structure with a touch input module, or may be integrally formed with the touch input module to implement a touch screen. The display module may be implemented as a Head Up Display (HUD). When the display module is implemented as an HUD, the display module may include a projection module to output information through an image projected onto a windshield or a window. The display module may include a transparent display. The transparent display may be attached to the windshield or the window. The transparent display may display a predetermined screen with a predetermined transparency. The transparent display may include at least one of a transparent thin film electroluminescent (TFEL), a transparent organic light-emitting diode (OLED), a transparent liquid crystal display (LCD), a transmissive transparent display, or a transparent light emitting diode (LED). The transparency of the transparent display may be adjusted. The vehicle user interface 1300 may include a plurality of display modules. The display module may be disposed on one area of a steering wheel, one area of an instrument panel, one area of a seat, one area of each pillar, one area of a door, one area of a center console, one area of a head lining, or one area of a sun visor, or may be implemented on one area of a windshield or one area of a window.

The sound output module may convert an electrical signal provided from the vehicle controller 1200 into an audio signal. The sound output module may include at least one speaker. The haptic output module generates a tactile output. For example, the haptic output module may operate to allow the user to perceive the output by vibrating a steering wheel, a seat belt, and a seat.

The driving controller 1400 may receive a user input for driving. In the manual mode, the host vehicle 1000 may be operated based on a signal provided by the driving controller 1400. That is, the driving controller 1400 receives an input for operating the host vehicle 1000 in the manual mode, and may include a steering input module, an acceleration input module, and a brake input module, but is not limited thereto.

The vehicle driving unit 1500 electrically controls driving of various devices in the host vehicle 1000 and includes, but not limited to, a power train driving module, a chassis driving module, a door/window driving module, a safety device driving module, a lamp driving module, and an air conditioning driving module.

The operator 1600 may control various operations of the host vehicle 1000, and in particular, may control various operations of the host vehicle 1000 in the autonomous driving mode. The operator 1600 may include, but not limited to, a driving module, an unparking module, and a parking module. The operator 1600 may include a processor under the control of the vehicle controller 1200. Each module of the operator 1600 may include a processor individually. Depending on the embodiment, when the operator 1600 is implemented as software, it may be a sub-concept of the vehicle controller 1200.

The driving module may perform driving of the vehicle 1000. The driving module may receive object information from the sensor unit 1700, and provide a control signal to the vehicle driving module to perform the driving of the vehicle 1000. The driving module may receive a signal from an external device through the vehicle communicator 1100, and provide a control signal to the vehicle driving module, so that the driving of the vehicle 1000 may be performed.

The unparking module may perform unparking of the vehicle 1000. The unparking module may receive navigation information from the navigation module, and provide a control signal to the vehicle driving module to perform the departure of the vehicle 1000. The unparking module can receive object information from the sensor unit 1700 and provide a control signal to the vehicle driving module so as to perform the unparking of the vehicle 1000. In the unparking module, a signal may be provided from an external device through the vehicle communicator 1100, and a control signal may be provided to the vehicle driving module, so that the unparking of the vehicle 1000 may be performed.

The parking module may perform parking of the vehicle 1000. The parking module may receive navigation information from the navigation module, and provide a control signal to the vehicle driving module to perform the parking of the vehicle 1000. The parking module may receive object information from the sensor unit 1700, and provide a control signal to the vehicle driving module so as to perform the parking of the vehicle 1000. In the parking module, a signal may be provided from the external device through the vehicle communicator 1100, and a control signal may be provided to the vehicle driving module so that the parking of the vehicle 1000 may be performed.

The navigation module may provide the navigation information to the vehicle controller 1200. The navigation information may include at least one of map information, set destination information, route information according to destination setting, information about various objects on the route, lane information, or current location information of the vehicle.

The navigation module may provide the vehicle controller 1200 with a parking lot map of the parking lot entered by the vehicle 1000. When the vehicle 1000 enters the parking lot, the vehicle controller 1200 receives the parking lot map from the navigation module, and projects the calculated route and fixed identification information on the provided parking lot map so as to generate the map data.

The navigation module may include a memory. The memory may store navigation information. The navigation information may be updated by information received through the vehicle communicator 1100. The navigation module may be controlled by an internal processor, or may operate by receiving an external signal, for example, a control signal from the vehicle controller 1200, but the present disclosure is not limited thereto. The driving module of the operator 1600 may be provided with the navigation information from the navigation module, and may provide a control signal to the vehicle driving module so that driving of the vehicle 1000 may be performed.

The sensor unit 1700 may sense the state of the vehicle 1000 using a sensor mounted on the vehicle 1000, that is, a signal related to the state of the vehicle 1000, and obtain movement route information of the vehicle 1000 according to the sensed signal. The sensor unit 1700 may provide the obtained movement route information to the vehicle controller 1200. In addition, the sensor unit 1700 may sense objects and the like around the host vehicle 1000 using a sensor mounted on the host vehicle 1000.

The sensor unit 1700 is for detecting an object located outside the vehicle 1000.

The sensor unit 1700 may generate object information based on the sensing data, and transmit the generated object information to the vehicle controller 1200. Examples of the object may include various objects related to the driving of the vehicle 1000, such as a lane, another vehicle, a pedestrian, a motorcycle, a traffic signal, light, a road, a structure, a speed bump, a landmark, and an animal. The sensor unit 1700 is a plurality of sensor modules, and may include a camera module as a plurality of imaging units, a light imaging detection and ranging (LIDAR), an ultrasonic sensor, a radio detection and ranging (RADAR), and an infrared sensor. The sensor unit 1700 may sense environmental information around the vehicle 1000 through a plurality of sensor modules.

Depending on the embodiment, the sensor unit 1700 may further include components other than the components described, or may not include some of the components described. The radar may include an electromagnetic wave transmitting module and an electromagnetic wave receiving module. The radar may be implemented using a pulse radar method or a continuous wave radar method in terms of radio wave emission principle. The radar may be implemented using a frequency modulated continuous wave (FMCW) method or a frequency shift keying (FSK) method according to a signal waveform in a continuous wave radar method. The radar may detect an object based on a time-of-flight (TOF) method or a phase-shift method using an electromagnetic wave as a medium, and detect the location of the detected object, the distance to the detected object, and the relative speed of the detected object. The radar may be disposed at an appropriate position outside the vehicle for sensing an object disposed at the front, back, or side of the vehicle.

The lidar may include a laser transmitting module, and a laser receiving module. The lidar may be embodied using the time of flight (TOF) method or in the phase-shift method. The lidar may be implemented using a driving method or a non-driving method. When the lidar is embodied in the driving method, the lidar may rotate by means of a motor, and detect an object near the vehicle 1000. When the lidar is implemented in the non-driving method, the lidar may detect an object within a predetermined range with respect to the vehicle 1000 by means of light steering. The vehicle 1000 may include a plurality of non-driven type lidars. The lidar may detect an object using the time of flight (TOF) method or the phase-shift method using laser light as a medium, and detect the location of the detected object, the distance from the detected object and the relative speed of the detected object. The lidar may be disposed at an appropriate position outside the vehicle for sensing an object disposed at the front, back, or side of the vehicle.

The imaging unit may be located at a suitable location outside a vehicle, for example, front, rear, right, and left mirrors of the vehicle in order to acquire an image outside the vehicle. The imaging unit may be a mono camera, but is not limited thereto, and may be a stereo camera, an around view monitoring (AVM) camera, or a 360° camera. The imaging unit may be disposed to be close to a front windshield in the interior of the vehicle to obtain an image in front of the vehicle. Alternatively, the imaging unit may be disposed around a front bumper or a radiator grille. The imaging unit may be disposed to be close to a rear glass in the interior of the vehicle to obtain an image behind the vehicle. Alternatively, the imaging unit may be disposed around a rear bumper, a trunk, or a tail gate. The imaging unit may be disposed to be close to at least one of side windows in the interior of the vehicle to acquire images next to a vehicle. In addition, the imaging unit may be disposed around a fender or a door.

The ultrasonic sensor may include an ultrasonic transmitting module, and an ultrasonic receiving module. The ultrasonic sensor may detect an object based on ultrasonic waves, and detect the location of the detected object, the distance from the detected object, and the relative speed of the detected object. The ultrasonic sensor may be disposed at an appropriate position outside the vehicle for sensing an object at the front, back, or side of the vehicle. The infrared sensor may include an infrared transmitting module, and an infrared receiving module. The infrared sensor may detect an object based on infrared light, and detect the location of the detected object, the distance from the detected object, and the relative speed of the detected object. The infrared sensor may be disposed at an appropriate position outside the vehicle for sensing an object at the front, back, or side of the vehicle.

The vehicle controller 1200 may control the overall operation of each module of the sensor unit 1700. The vehicle controller 1200 may compare data sensed by the radar, the lidar, the ultrasonic sensor, and the infrared sensor with pre-stored data so as to detect or classify an object. The vehicle controller 1200 may detect an object and perform tracking of the object based on the obtained image. The vehicle controller 1200 may perform operations such as calculation of the distance from an object and calculation of the relative speed of the object through image processing algorithms. For example, the vehicle controller 1200 may obtain the distance information from the object and the relative speed information of the object from the obtained image based on the change of size of the object over time. For example, the vehicle controller 1200 may obtain the distance information from the object and the relative speed information of the object through, for example, a pin hole model and road surface profiling. The vehicle controller 1200 may detect an object and perform tracking of the object based on the reflected electromagnetic wave reflected back from the object. The vehicle controller 1200 may perform operations such as calculation of the distance to the object and calculation of the relative speed of the object based on the electromagnetic waves.

The vehicle controller 1200 may detect an object, and perform tracking of the object based on the reflected laser light reflected back from the object. Based on the laser light, the vehicle controller 1200 may perform operations such as calculation of the distance to the object and calculation of the relative speed of the object based on the laser light. The vehicle controller 1200 may detect an object and perform tracking of the object based on the reflected ultrasonic wave reflected back from the object. The vehicle controller 1200 may perform operations such as calculation of the distance to the object and calculation of the relative speed of the object based on the reflected ultrasonic wave. The vehicle controller 1200 may detect an object and perform tracking of the object based on the reflected infrared light reflected back from the object. The vehicle controller 1200 may perform operations such as calculation of the distance to the object and calculation of the relative speed of the object based on the infrared light. Depending on the embodiment, the sensor unit 1700 may include a processor separate from the vehicle controller 1200. In addition, the radar, the lidar, the ultrasonic sensor, and the infrared sensor may each include a processor. When the sensor unit 1700 includes a processor, the sensor unit 1700 may be operated under the control of the processor under the control of the vehicle controller 1200.

The sensor unit 1700 may include a posture sensor (for example, a yaw sensor, a roll sensor, and a pitch sensor), a collision sensor, a wheel sensor, a speed sensor, a tilt sensor, a weight sensor, a heading sensor, a gyro sensor, a position module, a vehicle forward/reverse movement sensor, a battery sensor, a fuel sensor, a tire sensor, a steering sensor by rotation of a steering wheel, a vehicle interior temperature sensor, a vehicle interior humidity sensor, an ultrasonic sensor, an illuminance sensor, an accelerator pedal position sensor, and a brake pedal position sensor, but is not limited thereto. The sensor unit 1700 may acquire sensing signals for information such as vehicle posture information, vehicle collision information, vehicle direction information, vehicle position information (GPS information), vehicle angle information, vehicle speed information, vehicle acceleration information, vehicle tilt information, vehicle forward/reverse movement information, battery information, fuel information, tire information, vehicle lamp information, vehicle interior temperature information, vehicle interior humidity information, a steering wheel rotation angle, vehicle exterior illuminance, pressure on an acceleration pedal, and pressure on a brake pedal. The sensor unit 1700 may further include an acceleration pedal sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), but is not limited thereto. The sensor unit 1700 may generate vehicle status information based on sensing data. The vehicle state information may be information generated based on data sensed by various sensors provided in the vehicle. The vehicle status information may include at least one among posture information of the vehicle, speed information of the vehicle, tilt information of the vehicle, weight information of the vehicle, direction information of the vehicle, battery information of the vehicle, fuel information of the vehicle, tire air pressure information of the vehicle, steering information of the vehicle, vehicle interior temperature information, vehicle interior humidity information, pedal position information, and vehicle engine temperature information.

The vehicle storage 1800 may be electrically connected to the vehicle controller 1200. The vehicle storage 1800 may store basic data for each unit of the apparatus for controlling driving of a vehicle, control data for operation control of each unit of the vehicle, and input/output data. In the present embodiment, the vehicle storage 1800 may temporarily or permanently store data processed by the vehicle controller 1200. Here, the vehicle storage 1800 may include magnetic storage media or flash storage media, but the present disclosure is not limited thereto. This vehicle storage 1800 may include an internal memory and an external memory, and may include: a volatile memory such as a DRAM, SRAM, or SDRAM; a non-volatile memory such as a one time programmable ROM (OTPROM), PROM, EPROM, EEPROM, mask ROM, flash ROM, NAND flash memory, or NOR flash memory; and a storage device such as an HDD or a flash drive such as an SSD, compact flash (CF) card, SD card, micro-SD card, mini-SD card, Xd card, or a memory stick. The vehicle storage 1800 may store various data for overall operation of the vehicle 1000, such as a program for processing or controlling the vehicle controller 1200, in particular driver propensity information. The vehicle storage 1800 may be integrally formed with the vehicle controller 1200, or implemented as a sub-component of the vehicle controller 1200.

The processor 1900 may check an approaching vehicle located within a predetermined distance with respect to the host vehicle 1000, and may maintain a distance between the host vehicle 1000 and the preceding vehicle 2000 or the following vehicle 3000 to be within a predetermined distance based on at least one of the driving environment information including the vehicle information of the host vehicle 1000 and the road traffic information and the vehicle information of the preceding vehicle 2000 and the vehicle information of the following vehicle 3000 among the approaching vehicles. In addition, when the distance between the host vehicle 1000 and the preceding vehicle 2000 or the distance between the host vehicle 1000 and the following vehicle 3000 cannot be maintained within a predetermined distance, the processor 1900 may allow the host vehicle 1000 to enter the adaptive avoidance mode.

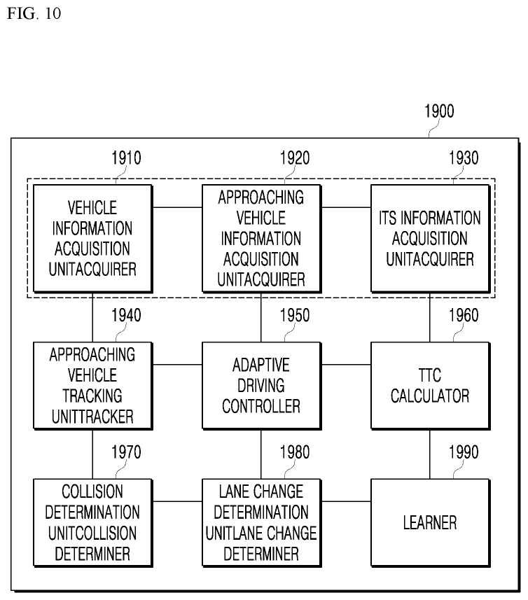

In the present embodiment, as illustrated in FIG. 3, the processor 1900 may be provided outside the vehicle controller 1200, provided inside the vehicle controller 1200, and inside the AI server 200 of FIG. 1. Detailed operation of the processor 1900 will be described with reference to FIG. 10.

The vehicle controller 1200 performs overall control of the vehicle, that is, the host vehicle 1000, and may analyze and process information and data input through the vehicle communicator 1100, the vehicle user interface 1300, the driving controller 1400, the sensor unit 1700, and the like or receive the results analyzed and processed by the processor 1900 to control the vehicle driving unit 1500 and the operator 1600. In addition, the vehicle controller 1200, which is a kind of central processing unit, may drive control software mounted in the vehicle storage 1800 to control the overall operation of the apparatus for controlling driving of a vehicle.

In the present embodiment, the vehicle controller 1200 may check the approaching vehicle located within a predetermined distance with respect to the host vehicle 1000 through the sensor unit 1700, and acquire the driving environment information including the vehicle information of the host vehicle 1000 and the road traffic information and the vehicle information of the preceding vehicle 2000 and/or the following vehicle 3000 through the vehicle communicator 1100 and the sensor unit 1700. Further, the vehicle controller 1200 may control the host vehicle 1000 in the adaptive cruise mode using the operator 1600 so that the distance between the host vehicle 1000 and the preceding vehicle 2000 and/or the following vehicle 3000 is maintained within the predetermined distance based on the driving environment information of the host vehicle 1000 and the vehicle information of the preceding vehicle 2000 and/or the following vehicle 3000. Meanwhile, if it is determined that the distance between the host vehicle 1000 and the preceding vehicle 2000 or the distance between the host vehicle 1000 and the following vehicle 3000 cannot be maintained within the predetermined distance, the vehicle controller 1200 may control the host vehicle 1000 in the adaptive avoidance mode. In the adaptive avoidance mode, the vehicle controller 1200 determines whether a lane can be changed using the vehicle communicator 1100 and the sensor unit 1700 to change a lane or warn the preceding vehicle 2000 and the following vehicle 3000 using the vehicle communicator 1100 and the vehicle driving unit 1500.

Here, the vehicle controller 1200 may include all kinds of devices capable of processing data like a processor. Here, the term “processor” may represent, for example, a hardware-embedded data processing device having a physically structured circuit to execute functions expressed as instructions or codes included in a program. Examples of a data processing device embedded in hardware may include processing devices such as a microprocessor, a central processing unit (CPU), a processor core, a multiprocessor, and an application-specific integrated circuit (ASIC), digital signal processors (DSPs), digital signal processing devices (DSPDs), programmable logic devices (PLDs), processors, controllers, micro-controllers, field programmable gate arrays (FPGA), but the scope of the present disclosure is not limited thereto.

In the present embodiment, the vehicle controller 1200 may check the approaching vehicle of the apparatus for controlling driving of a vehicle, identify the driving pattern of the approaching vehicle, determine the collision possibility, determine and check whether a lane can be changed, recognize the real-time change in space, calculate the vehicle driving control data according to the recognized real-time change in space, acquire a voice command, and perform machine learning such as deep learning on the operation of the apparatus for controlling driving of a vehicle corresponding to the voice command, a user-customized operation and the like, and the vehicle storage 1800 may store data, result data, and the like used for the machine learning.

Deep learning technique, which is a subfield of machine learning, enables data-based learning through multiple layers. As the number of layers in deep learning increases, the deep learning network may acquire a collection of machine learning algorithms that extract core data from multiple datasets.

Deep learning structures may include an artificial neural network (ANN), and may include a convolutional neural network (CNN), a recurrent neural network (RNN), a deep belief network (DBN), and the like. The deep learning structure according to the present embodiment may use various structures well known in the art. For example, the deep learning structure according to the present disclosure may include a CNN, an RNN, a DBN, and the like. RNN is an artificial neural network structure which is formed by building up layers at each instance, and which is heavily used in natural language processing and the like and effective for processing time-series data which vary over a course of time. A DBN includes a deep learning structure formed by stacking up multiple layers of a deep learning scheme, restricted Boltzmann machines (RBM). A DBN has the number of layers formed by repeating RBM training. CNN includes a model mimicking a human brain function, built on the assumption that when a person recognizes an object, the brain extracts basic features of the object and recognizes the object based on the results of complex processing in the brain.

Further, the artificial neural network may be trained by adjusting weights of connections between nodes (if necessary, adjusting bias values as well) so as to produce a desired output from a given input. Also, the artificial neural network can continuously update the weight values through learning. Furthermore, methods such as back propagation may be used in training the artificial neural network.

That is, an artificial neural network may be installed in the vehicle driving control device, and the vehicle controller 1200 may include an artificial neural network, for example, a deep neural network (DNN) such as CNN, RNN, DBN, or the like. Therefore, the vehicle controller 1200 may check the vehicle driving control approaching vehicle, identify the driving pattern of the approaching vehicle, determine the collision possibility, determine whether a lane can be changed, recognize the real-time change in space, calculate the vehicle driving control data according to the recognized real-time change in space, acquire the voice command, and learn the deep neural network for the operation of the apparatus for controlling driving of a vehicle corresponding to the voice command and the user-customized operation. Machine learning paradigms, in which the ANN operates, may include unsupervised learning and supervised learning. The vehicle controller 1200 may control so as to update an artificial neural network structure after learning according to a setting.

FIG. 10 is a schematic block diagram of a processor of the apparatus for controlling driving of a vehicle according to the embodiment of the present disclosure of FIG. 3. In the following description, the description of the overlapping portions with the description of FIGS. 1 to 9 will be omitted. Referring to FIG. 10, the processor 1900 may include a host vehicle information acquirer 1910, an approaching vehicle information acquirer 1920, a ITS information acquirer 1930, an approaching vehicle tracker 1940, an adaptive driving controller 1950, a TTC calculator 1960, a collision determiner 1970, a lane change determiner 1980, and a learner 1990.

Meanwhile, in the present embodiment, the host vehicle information acquirer 1910, the approaching vehicle information acquirer 1920, and the ITS information acquirer 1930 may be collectively referred to as an acquirer.

The host vehicle information acquirer 1910 may acquire the driving environment information including the vehicle information of the host vehicle 1000 and the road traffic information. The vehicle information of the host vehicle 1000 may include all information on the vehicle that can be obtained through the vehicle communicator 1100 and the sensor unit 1700 such as a vehicle speed and a vehicle location. In addition, the vehicle information of the host vehicle 1000 may include the steering information and the like through the driving controller 1400.

The approaching vehicle information acquirer 1920 may acquire the vehicle information of the approaching vehicle located within a predetermined distance with respect to the host vehicle 1000. For example, the approaching vehicle information acquirer 1920 may acquire the vehicle information of the approaching vehicles located at front, rear, left, and right sides within a distance that can be sensed by the sensor unit 1700 of the host vehicle 1000. However, the present disclosure is not limited thereto, and vehicle information of remote vehicles not located within a predetermined distance from a server or the like may also be obtained through the vehicle communicator 1100. In this case, the vehicle information of the approaching vehicle may include a vehicle speed, a vehicle location, a vehicle driving pattern, and the like, the vehicle information of the approaching vehicle may be acquired by the sensing of the sensor unit 1700 of the host vehicle 1000, and the vehicle information may be received and obtained from the approaching vehicle through the vehicle communicator 1100.

The ITS information acquirer 1930 obtains road traffic information, and may receive and obtain the road traffic information from the ITS server and the like through the vehicle communicator 1100. For example, the ITS information acquirer 1930 may acquire all information related to the outside of the vehicle such as traffic information, information on a road on which a vehicle is currently driving, surrounding infrastructure information, sun position, and weather

On the other hand, the acquirer may receive the driving environment information of the host vehicle 1000 and the vehicle information of the preceding vehicle 2000 or the following vehicle 3000 based on a downlink grant of a connected 5G network for driving the host vehicle 1000 equipped with the apparatus for controlling driving of a vehicle in the autonomous driving mode, and may receive at least some of the driving environment information of the host vehicle 1000 from the ITS server connected to the 5G network.

The approaching vehicle tracker 1940 tracks the approaching vehicle located within a predetermined distance with respect to the host vehicle 1000, and may identify, in particular, the presence or absence of the preceding vehicle 2000 and the following vehicle 3000, the locations of the preceding vehicle 2000 and the following vehicle 3000 (distance from the host vehicle), the driving patterns of the preceding vehicle 2000 and the following vehicle 3000, and the like. In the adaptive avoidance mode, the approaching vehicle tracker 1940 may check and track whether a vehicle exists in a rear of a lane existing on the left and right sides of the host vehicle 1000 to determine whether the lane is changed. That is, the approaching vehicle tracker 1940 may acquire and track the vehicle information of the approaching vehicle for a predetermined time, acquire the road traffic information from the ITS server for a predetermined time, and analyze the driving pattern of the approaching vehicle based on the tracking information and the road traffic information of the approaching vehicle for a predetermined time. In this case, the predetermined time may be set in advance and may be changed.

The adaptive driving controller 1950 may control the host vehicle 1000 in the adaptive cruise mode so that the distance between the host vehicle 1000 and the preceding vehicle 2000 and/or the following vehicle 3000 is maintained within the predetermined distance based on the driving environment information of the host vehicle 1000 and the vehicle information of the preceding vehicle 2000 and/or the following vehicle 3000. In addition, when the distance between the host vehicle 1000 and the preceding vehicle 2000 or the distance between the host vehicle 1000 and the following vehicle 3000 cannot be maintained within a predetermined distance, the adaptive driving controller 1950 may control the host vehicle 1000 in the adaptive avoidance mode.

That is, the adaptive driving controller 1950 may classify scenarios according to the presence or absence of at least one of the preceding vehicle 2000 and the following vehicle 3000 and perform control to enable the adaptive driving of the host vehicle 1000.

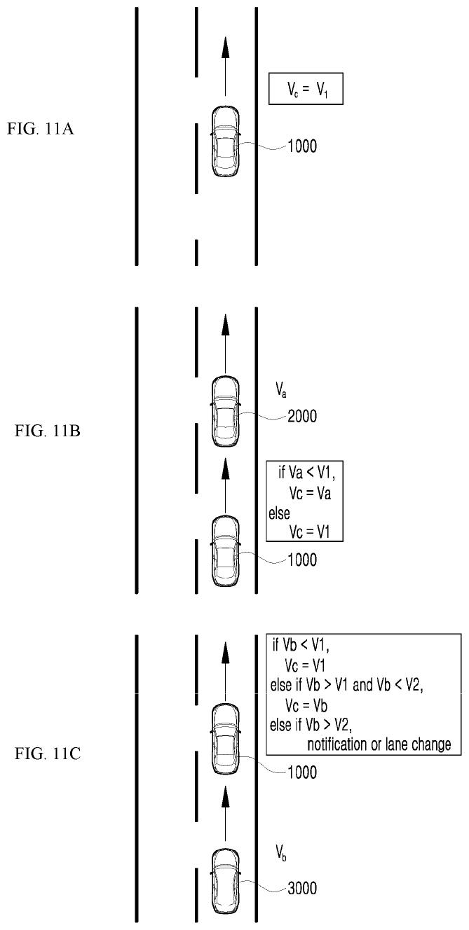

FIGS. 11A to 11C are exemplary diagrams for describing the adaptive cruise mode of the apparatus for controlling driving of a vehicle according to the embodiment of the present disclosure when both a preceding vehicle and a following vehicle are not present or only one of the preceding vehicle and the following vehicle is present.

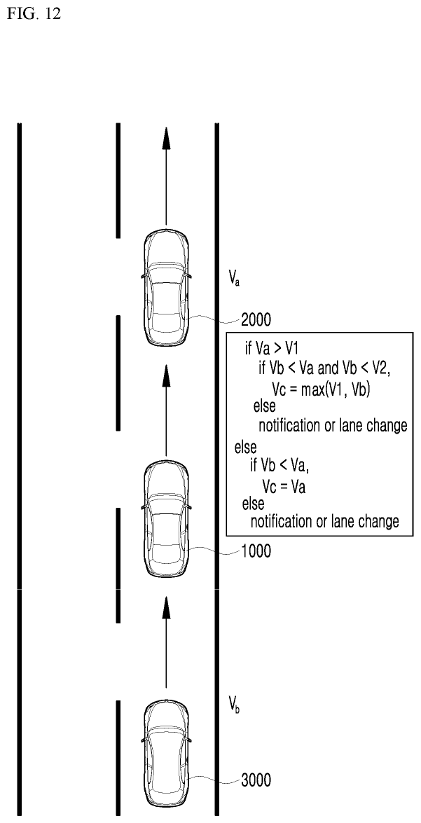

FIG. 12 is an exemplary diagram for describing the adaptive cruise mode of the apparatus for controlling driving of a vehicle according to the embodiment of the present disclosure between the preceding vehicle and the following vehicle.

Referring to FIGS. 11A to 12, in the present embodiment, the scenario may be classified into four cases such as a case where the preceding vehicle 2000 and the following vehicle 3000 are not present, a case where only the preceding vehicle 2000 is present, a case where only the following vehicle 3000 is present, and a case where both the preceding vehicle 2000 and the following vehicle 3000 are present.

FIG. 11A illustrates the case where the preceding vehicle 2000 and the following vehicle 3000 are not present. In this case, the adaptive driving controller 1950 may set a speed V_{c} of the host vehicle 1000 as a first setting speed V₁. Here, the first setting speed V₁ may be a maximum speed when the preceding vehicle 2000 and the following vehicle 3000 are not within a predetermined distance, which may be set based on a road regulation speed and the like and may be a setting value at the time of a general cruise control.

FIG. 11B illustrates a case in which only the preceding vehicle 2000 is present within a predetermined distance. In this case, the adaptive driving controller 1950 may perform the cruise control in response to the speed of the preceding vehicle 2000. That is, when a speed Vₐ of the preceding vehicle is less than the first setting speed V₁, the adaptive driving controller 1950 may set the speed V_{c} of the host vehicle 1000 as the preceding vehicle speed Vₐ. However, when the speed Vₐ of the preceding vehicle is equal to or more than the first setting speed V₁, the adaptive driving controller 1950 may set the speed V_{c} of the host vehicle 1000 as the first setting speed V₁.

FIG. 11C illustrates the case in which only the following vehicle 3000 is present within a predetermined distance. In this case, the adaptive driving controller 1950 performs basic driving at the first setting speed V₁, but if the speed of the following vehicle 3000 is further increased, the vehicle of the host vehicle 1000 may be increased to maintain a distance. That is, when the speed V_{b} of the following vehicle 3000 is less than the first setting speed V₁, the adaptive driving controller 1950 may set the speed V_{c} of the host vehicle 1000 as the first setting speed V₁. Otherwise, when the speed V_{b} of the following vehicle 3000 exceeds the first setting speed V₁ and is lower than a second setting speed V2, the adaptive driving controller 1950 may set the speed V_{c} of the host vehicle 1000 as the speed V_{b} of the following vehicle 3000. In addition, when the speed V_{b} of the following vehicle 3000 exceeds the second setting speed V2, the adaptive driving controller 1950 may output a notification to the following vehicle 3000 or perform a lane change. In this case, the notification output and the lane change may operate together. That is, if the speed becomes too fast, the following vehicle 3000 is warned so that the following vehicle can slow down. In this case, the second setting speed V2 is a maximum speed for maintaining the distance from the following vehicle 3000, and may be set to be a value greater than the first setting speed V₁.

FIG. 12 illustrates the case where the preceding vehicle 2000 and the following vehicle 3000 are located within a predetermined distance. In this case, the adaptive driving controller 1950 may perform the general cruise control in response to the preceding vehicle 2000, and notify or warn the following vehicle 3000 or allow the following vehicle 3000 to perform a lane change when the following vehicle 3000 enters a safety distance. In this case, the notification or warning and the lane change may operate together. More specifically, when the vehicle Vₐ of the preceding vehicle exceeds the first setting speed V₁, if the speed V_{b} of following vehicle 3000 is less than the speed Vₐ of the preceding vehicle and the speed V_{b} of following vehicle 3000 is less than the second setting speed V₂, the adaptive driving controller 1950 may set the speed V_{c} of the host vehicle 1000 to be a larger value of the first setting speed V₁ and the speed V_{b} of the following vehicle 3000. Otherwise, if the speed V_{b} of the following vehicle 3000 exceeds the Vₐ of the preceding vehicle and the speed V_{b} of the following vehicle 3000 exceeds the second setting speed V₂, the adaptive driving controller 1950 may output the notification and warning or perform the lane change. In the present embodiment, the notification or the warning may be output and the lane change may be performed, and the notification or the warning may be simultaneously output to the preceding vehicle 2000 and the following vehicle 3000. In addition, when the speed Vₐ of the preceding vehicle is less than the first setting speed V₁, if the speed V_{b} of the following vehicle 3000 is less than the speed Vₐ of the preceding vehicle, the adaptive driving controller 1950 may set the speed V_{c} of the host vehicle 1000 as the speed Vₐ of the preceding vehicle, and if the speed V_{b} of the following vehicle 3000 exceeds the speed Vₐ of the preceding vehicle, the adaptive driving controller 1950 may output the notification or warning or perform the lane change. In the present embodiment, the notification or the warning may be output and the lane change may be performed, and the notification or the warning may be simultaneously output to the preceding vehicle 2000 and the following vehicle 3000.

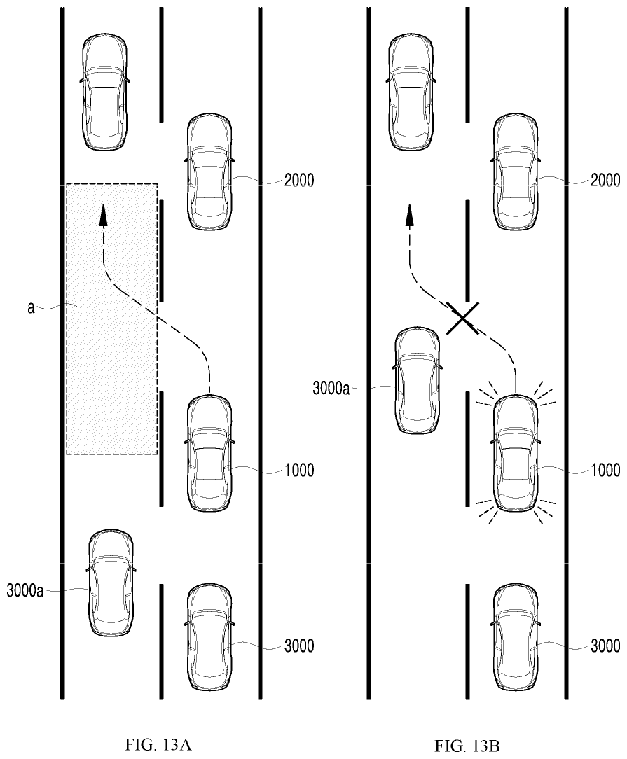

FIGS. 13A and 13B are exemplary diagrams for describing the adaptive avoidance mode of the apparatus for controlling driving of a vehicle according to the embodiment of the present disclosure.

Referring to FIGS. 13A and 13B, when the distance between the host vehicle 1000 and the preceding vehicle 2000 or the distance between the host vehicle 1000 and the following vehicle 3000 cannot be maintained within a predetermined distance, the adaptive driving controller 1950 may control the host vehicle 1000 in the adaptive avoidance mode. That is, when it is possible to perform the lane change by identifying the possibility of the lane change in the case of the adaptive avoidance mode control, the adaptive driving controller 1950 performs the lane change (FIG. 13A), when it is impossible to perform the lane change, the adaptive driving controller 1950 may notify or warn the approaching vehicle of this situation to enable driving without a collision (FIG. 13B). More specifically, the adaptive driving controller 1950 may calculate a time to collision (TTC) with the preceding vehicle 2000 and/or the following vehicle 3000 to determine the locations of the preceding vehicle 2000 and/or the following vehicle 3000 based on the time to collision and enable the appropriate avoidance driving according to the locations.

The TTC calculator 1960 may calculate the time to collision (TTC) calculated based on the vehicle information of the preceding vehicle 2000 and the distance between the host vehicle 1000 and the preceding vehicle 2000, and calculate the time to collision calculated based on the vehicle information of the following vehicle 3000 and the distance between the host vehicle 1000 and the following vehicle 3000. Here, the time to collision (TTC) is a value obtained by dividing the distance between the host vehicle 1000 and the preceding vehicle 2000 or the following vehicle 3000 by the relative speed, and may mean the time required for the subject vehicle to hit the target vehicle when the approaching speed of the subject vehicle is constant. That is, the TTC calculator 1960 may calculate the time to collision based on the distance between the preceding vehicle 2000 or the following vehicle 3000 and the relative speed with the preceding vehicle 2000 or the following vehicle 3000. However, the present disclosure is not limited thereto, and the time to collision may be more accurately calculated by reflecting the driving patterns of the vehicle 1000, the preceding vehicle 2000, and the following vehicle 3000 reflecting the change in movement such as speed, acceleration, deceleration, direction change, and relative acceleration, signals such as head lamps, and the surrounding environment information such as sun position and weather. That is, in the present embodiment, since the driving pattern is different for each vehicle, the time to collision may be calculated based on the driving pattern tracked by the approaching vehicle tracker 1940.

The collision determiner 1970 may determine that at least one of the preceding vehicle 2000 and the following vehicle 3000 is located in a collision reserve section based on the time to collision, or determine that at least one of the preceding vehicle 2000 and the following vehicle 3000 is located in a collision danger section. That is, the collision determiner 1970 may determine that the corresponding vehicle is located in the collision reserve section if the time to collision is less than a first collision setting time and is equal to or more than a second collision setting time, and determine that the corresponding vehicle is located in the collision danger section if the time to collision is less than the second collision setting time. In this case, the first collision setting time may be set to be a value larger than the second collision setting time.

In the present embodiment, by dividing four cases such as the case where the preceding vehicle 2000 is in the collision reserve section, the case where the preceding vehicle 2000 is in the collision danger section, the case where the following vehicle 3000 is in the collision reserve section, and the case where the following vehicle 3000 is in the collision danger section, the host vehicle 1000 may be controlled in the adaptive avoidance mode. More specifically, the adaptive driving controller 1950 may warn the preceding vehicle 2000 when the preceding vehicle 2000 is located in the collision reserve section and the speed of the preceding vehicle 2000 is equal to or smaller than a threshold value. When the preceding vehicle 2000 is located in the collision reserve section and the following vehicle 3000 is located in a section other than the collision reserve section and the collision danger section, the adaptive driving controller 1950 decelerates the host vehicle 1000 corresponding to the speed of the preceding vehicle 2000 and when the following vehicle 3000 is located in the collision reserve section and the following vehicle 3000 is located in the collision reserve section, the adaptive driving controller 1950 may warn the following vehicle 3000. In addition, when the preceding vehicle 2000 is located in the collision reserve section and the following vehicle 3000 is located in the collision danger section, the adaptive driving controller 1950 may determine whether the host vehicle 1000 can perform a lane change.

Meanwhile, the adaptive driving controller 1950 may warn the preceding vehicle 2000 when the preceding vehicle 2000 is located in the collision danger section and the speed of the preceding vehicle 2000 is less than or equal to the threshold value. When the preceding vehicle 2000 is located in the collision danger section and the following vehicle 3000 is located in the section other than the collision reserve section and the collision danger section, the adaptive driving controller 1950 corresponds to the speed of the preceding vehicle 2000 to decelerate the host vehicle 1000 and when the preceding vehicle 2000 is located in the collision danger section and the following vehicle 300 is located in the collision reserve section or the collision danger section, the adaptive driving controller 1950 may warn the following vehicle 3000 and determine whether the host vehicle 1000 can perform the lane change.

In addition, the adaptive driving controller 1950 may accelerate the host vehicle 1000 corresponding to the speed of the following vehicle 3000 when the following vehicle 3000 is located in the collision reserve section and the preceding vehicle 2000 is located in the section other than the collision reserve section and the collision danger section. The adaptive driving controller 1950 may warn the preceding vehicle 2000 when the following vehicle 3000 is located in the collision reserve section and the preceding vehicle 2000 is located in the collision reserve section, and may determine whether the host vehicle 1000 can perform the lane change when the following vehicle 3000 is located in the collision reserve section and the preceding vehicle 2000 is located in the collision danger section.

In addition, the adaptive driving controller 1950 may accelerate the host vehicle 1000 corresponding to the speed of the following vehicle 3000 when the following vehicle 3000 is located in the collision danger section and the preceding vehicle 2000 is located in the section other than the collision reserve section and the collision danger section. When the following vehicle 3000 is located in the collision danger section and the following vehicle 3000 is located in the collision reserve section and the collision danger section, the adaptive driving controller 1950 may warn the following vehicle 3000 and determine whether the host vehicle 1000 can perform the lane change.

The lane change determiner 1980 may determine whether lanes exist on the left and right sides of the host vehicle 1000 and whether a vehicle exists behind the left and right rear sides of the host vehicle 1000, and set a movable lane of the host vehicle 1000 and a movable space (FIG. 13A) of the movable lane. The lane change determining unit 1980 may calculate the time to collision based on vehicle information of a following vehicle 3000a of the movable lane and a distance between a reference point of the movable space and the following vehicle 3000a. In this case, when the time to collision increases, the adaptive driving controller 1950 may change a lane of the host vehicle 1000 to the movable lane. In this case, the lane change determiner 1980 may receive road information from the server or the like through the V₂X communication using the vehicle communicator 1100, and may determine whether lanes exist on the left and right sides, and may also determine through HD-MAP. The HD-MAP may be stored in the vehicle storage 1800 or downloaded from the server or the like through the vehicle communicator 1100.

Meanwhile, in the present embodiment, examples of a method for warning a preceding vehicle 2000 include a method for rapidly blinking a lamp such as a head lamp, a method for honking a horn, a method for issuing a warning through vehicle-to-vehicle communication (V₂V) using a vehicle communicator 1100, or the like. In addition, examples a method for warning a following vehicle 3000 may include a method for rapidly blinking a brake light or an emergency light while slowly decelerating, a method for issuing a warning through vehicle-to-vehicle communication (V2V) using a vehicle communicator 1100, or the like.

Meanwhile, in the present embodiment, parameters for learning a deep neural network learned in advance may be collected. In this case, the parameters for learning the deep neural network may include driving environment information data of the host vehicle 1000, vehicle information data of the approaching vehicle, ITS information data, vehicle driving control data according to real-time change in space, and the like. In addition, the parameters may include a voice command, an operation of the apparatus for controlling driving of a vehicle corresponding to the voice command, and user-customized operation data. However, in the present embodiment, the parameters for learning the deep neural network are not limited thereto. In this embodiment, data used by an actual user may be collected to refine the learning model. That is, in the present embodiment, the user data may be input from the user through the vehicle communicator 1100 and the vehicle user interface 1300. In addition, the apparatus for controlling driving of a vehicle may store driving data in a server and/or a memory regardless of the results of the learning model, for example, when the user directly controls driving through the driving controller 1400 according to driving conditions. That is, in the present embodiment, the apparatus for controlling driving of a vehicle may store data generated while the vehicle is driving in the server to configure big data, and execute deep learning at the server end to update related parameters in the apparatus for controlling driving of a vehicle, so that the related parameters may be gradually sophisticated. However, in the present embodiment, the update may also be performed by executing the deep learning by itself at the edge end of the apparatus for controlling driving of a vehicle or the vehicle. That is, in the present embodiment, when the apparatus for controlling driving of a vehicle is initially released, the deep learning parameters of laboratory conditions may be embedded, and the update may be performed through data accumulated as a user drives the vehicle. Therefore, in the present embodiment, the collected data may be labeled to obtain a result through training learning, and may be stored in a memory in the apparatus for controlling driving of a vehicle to complete an evolutionary algorithm. That is, the apparatus for controlling driving of a vehicle may collect data for adaptive driving control, generate a learning data set, and learn the learning data set through a machine learning algorithm to determine a learned model. In addition, the apparatus for controlling driving of a vehicle may generate a re-learned model by collecting data used by an actual user and re-learning the data on the server. Therefore, in the present embodiment, even after the determination is performed by the learned model, data may be continuously collected, the re-learning is performed by applying a machine learning model, and the performance may be improved by the re-learned model.

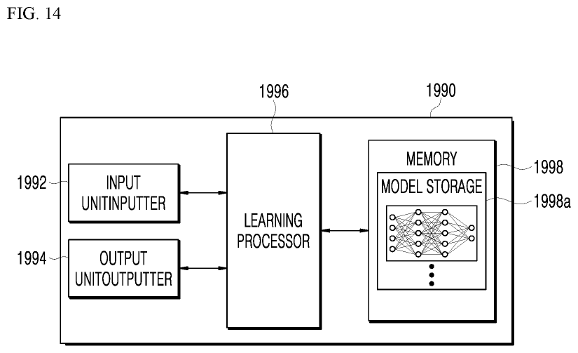

FIG. 14 is a schematic block diagram of a learner of the apparatus for controlling driving of a vehicle according to the embodiment of the present disclosure of FIG. 3. In the following description, description of the parts that are the same as those in FIG. 1 to FIG. 13B will be omitted.

Referring to FIG. 14, a learner 1990 may include an inputter 1992, an outputter 1994, a learning processor 1996, and a memory 1998.

The learner 1990 may mean an apparatus, system, or server that learns an artificial neural network using a machine learning algorithm or uses a learned artificial neural network. Here, the learner 1990 may be configured to include a plurality of servers to perform distributed processing, or may be defined as a 5G network. In this case, the learner 1990 may be included as a part of the apparatus for controlling driving of a vehicle and perform at least a part of AI processing together.

The inputter 1992 may receive, as input data, the vehicle information of the host vehicle 1000, the road traffic information from the ITS server, and the vehicle information of the approaching vehicle located within a predetermined distance with respect to the host vehicle 1000.

The learning processor 1996 may apply the received input data to a learning model for extracting the adaptive driving data of the host vehicle 1000 according to the change in space around the host vehicle 1000. The learning processor 1996 may learn the artificial neural network using the learned data. The learning model may be used mounted in the AI server of the artificial neural network (200 of FIG. 1), or may be used mounted in an external device.

The outputter 1994 may output the adaptive driving data according to the change in space around the host vehicle 1000 from the learning model.

In this case, the learning model may be learned to generate the adaptive driving data according to the adaptive cruise mode or the adaptive avoidance mode based on the pre-calculated change state in space around the host vehicle 1000 and the plurality of pre-input data to correspond to the vehicle information of the host vehicle 1000 and the road traffic information and the vehicle information data of the approaching vehicle, respectively, which are input in advance in order to recognize the change in space around the host vehicle 1000.

The memory 1998 may include a model storage 1998a. The model storage 1998a may store a model (or an artificial neural network) learning or learned via the learning processor 1996. The learning model may be implemented as hardware, software, or a combination of hardware and software. When a portion or the entirety of the learning model is implemented as software, one or more instructions, which constitute the learning model, may be stored in the memory 1998.

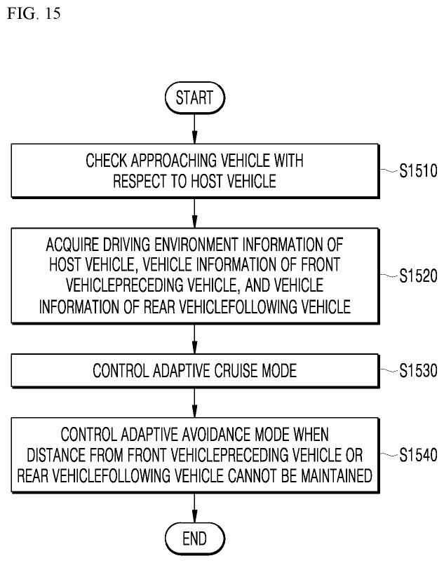

FIG. 15 is a flowchart illustrating a method for controlling driving of a vehicle according to an embodiment of the present disclosure. In the following description, the description of the overlapping portions with the description of FIGS. 1 to 14 will be omitted.

Referring to FIG. 15, in step S1510, the apparatus for controlling driving of a vehicle checks an approaching vehicle based on the host vehicle 1000. In the present embodiment, the approaching vehicle located within a predetermined distance with respect to the host vehicle 1000 may be tracked to identify, in particular, the presence or absence of the preceding vehicle 2000 and the following vehicle 3000, the locations of the preceding vehicle 2000 and the following vehicle 3000 (distance from the host vehicle), the driving patterns of the preceding vehicle 2000 and the following vehicle 3000, and the like. That is, the apparatus for controlling driving of a vehicle may acquire and track the vehicle information of the approaching vehicle for a predetermined time, acquire the road traffic information from the ITS server for a predetermined time, and analyze the driving pattern of the approaching vehicle based on the tracking information of the approaching vehicle and the road traffic information for a predetermined time. In this case, the predetermined time may be set in advance and may be changed.

In step S1520, the apparatus for controlling driving of a vehicle acquires at least one of the driving environment information of the host vehicle 1000, the vehicle information of the preceding vehicle 2000, and the vehicle information of the following vehicle 3000. The apparatus for controlling driving of a vehicle may acquire the driving environment information including the vehicle information of the host vehicle 1000 and the road traffic information. The vehicle information of the host vehicle 1000 may include all information on the vehicle that can be obtained through the vehicle communicator 1100 and the sensor unit 1700 such as a vehicle speed and a vehicle location. The apparatus for controlling driving of a vehicle may acquire the vehicle information of the approaching vehicle located within a predetermined distance with respect to the host vehicle 1000. For example, the apparatus for controlling driving of a vehicle may acquire the vehicle information of the approaching vehicles located at the front, rear, left, and right sides within a distance that can be sensed by the sensor unit 1700 of the host vehicle 1000. In this case, the vehicle information of the approaching vehicle may include the vehicle speed, the vehicle location, the vehicle driving pattern, and the like, the vehicle information of the approaching vehicle may be acquired by the sensing of the sensor unit 1700 of the host vehicle 1000, and the vehicle information may be received and obtained from the approaching vehicle through the vehicle communicator 1100. In addition, the apparatus for controlling driving of a vehicle may receive and acquire the road traffic information from the ITS server and the like through the vehicle communicator 1100. For example, the apparatus for controlling driving of a vehicle may acquire all information related to the outside of the vehicle such as traffic information, information on a road on which a vehicle is currently driving, surrounding infrastructure information, sun position, and weather.

In step S1530, the apparatus for controlling driving of a vehicle controls the host vehicle 1000 in the adaptive cruise mode. The apparatus for controlling driving of a vehicle may control the host vehicle 1000 in the adaptive cruise mode so that the distance between the host vehicle 1000 and the preceding vehicle 2000 and/or the following vehicle 3000 is maintained within the predetermined distance based on the driving environment information of the host vehicle 1000 and the vehicle information of at least one of the preceding vehicle 2000 and the following vehicle 3000.

In step S1540, when the distance from the preceding vehicle 2000 or the following vehicle 3000 cannot be maintained, the apparatus for controlling driving of a vehicle controls the host vehicle 1000 in the adaptive avoidance mode. That is, when the distance between the host vehicle 1000 and the preceding vehicle 2000 or the distance between the host vehicle 1000 and the following vehicle 3000 cannot be maintained within a predetermined distance, the apparatus for controlling driving of a vehicle may control the host vehicle 1000 in the adaptive avoidance mode.

That is, in the present embodiment, apparatus for controlling driving of a vehicle may classify scenarios according to the presence or absence of at least one of the preceding vehicle 2000 and the following vehicle 3000 and perform control to enable the adaptive driving of the host vehicle 1000. In particular, in the present embodiment, when both the preceding vehicle 2000 and the following vehicle 3000 exist, the driving control may be performed in the adaptive cruise mode according to the real-time change. When the distance between the host vehicle 1000 and the preceding vehicle 2000 or the distance between the host vehicle 1000 and the following vehicle 3000 cannot be maintained within a predetermined distance, the apparatus for controlling driving of a vehicle may control the host vehicle 1000 in the adaptive avoidance mode. Hereinafter, the method for controlling an adaptive avoidance mode will be described.

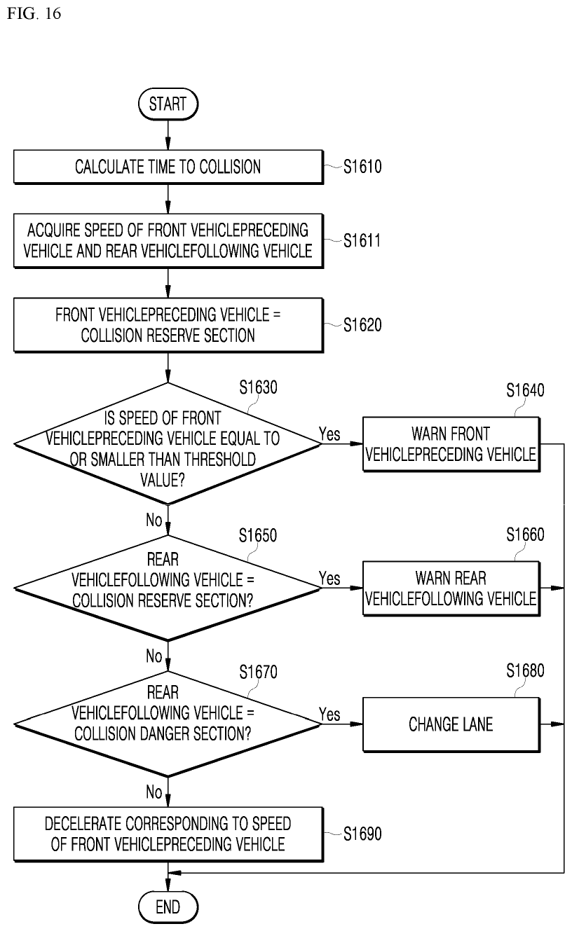

FIGS. 16 to 19 are flowcharts illustrating a method for controlling an adaptive avoidance mode of an apparatus for controlling driving of a vehicle according to an embodiment of the present disclosure. In the following description, the description of the overlapping portions with the description of FIGS. 1 to 15 will be omitted.

Referring to FIG. 16, in step S1610, the time to collision (TTC) calculated based on the vehicle information of the preceding vehicle 2000 and the distance between the host vehicle 1000 and the preceding vehicle 2000 is calculated, and the time to collision calculated based on the vehicle information of the following vehicle 3000 and the distance between the host vehicle 1000 and the following vehicle 3000 is calculated. Here, the time to collision (TTC) is a value obtained by dividing the distance between the host vehicle 1000 and the preceding vehicle 2000 or the following vehicle 3000 by the relative speed, and may mean the time required for the subject vehicle to hit the target vehicle when the approaching speed of the subject vehicle is constant. In the present embodiment, the time to collision may be more accurately calculated by reflecting the driving patterns of the vehicle 1000, the preceding vehicle 2000, and the following vehicle 3000 reflecting the change in movement such as speed, acceleration, deceleration, direction change, and relative acceleration, signals such as headlamps, and the surrounding environment information such as sun position and weather. That is, in the present embodiment, since the driving pattern is different for each vehicle, the time to collision may be calculated based on the driving pattern of the host vehicle 1000 and the approaching vehicles.

In step S1611, the apparatus for controlling driving of a vehicle acquires the speed of at least one of the preceding vehicle 2000 and the following vehicle 3000.

In step S1620, the apparatus for controlling driving of a vehicle checks whether the preceding vehicle 2000 is located in the collision reserve section. In the present embodiment, the apparatus for controlling driving of a vehicle may determine whether or not the preceding vehicle 2000 is located in the collision reserve section based on the time to collision. For example, the apparatus for controlling driving of a vehicle may determine that the preceding vehicle 2000 is located in the collision reserve section when the time to collision of the preceding vehicle 2000 is less than a first collision setting time and equal to or larger than a second collision setting time. In this case, the first collision setting time may be set to be a value larger than the second collision setting time.

In step S1630, the apparatus for controlling driving of a vehicle determines whether the speed of the preceding vehicle 2000 is equal to or smaller than a threshold value. At this time, the threshold value may be set to be the road regulation speed.

In step S1640, when the speed of the preceding vehicle 2000 is equal to or smaller than the threshold value (YES in S1630), the apparatus for controlling driving of a vehicle warns the preceding vehicle 2000. In the present embodiment, examples of a method for warning a preceding vehicle 2000 include a method for rapidly blinking a lamp such as a head lamp, a method for honking a horn, or a method for issuing a warning through vehicle-to-vehicle communication (V2V) using a vehicle communicator 1100.

In step S1650, the apparatus for controlling driving of a vehicle checks whether the following vehicle 3000 is located in the collision reserve section (NO in S1630). For example, the apparatus for controlling driving of a vehicle may determine that the following vehicle 3000 is located in the collision reserve section when the time to collision of the following vehicle 3000 is less than the first collision setting time and equal to or more than the second collision setting time.

In step S1660, when the following vehicle 3000 is located in the collision reserve section (YES in S1650), the apparatus for controlling driving of a vehicle warns the following vehicle 3000. In the present embodiment, examples a method for warning a following vehicle 3000 may include a method for rapidly blinking a brake light or an emergency light while slowly decelerating, a method for issuing a warning through vehicle-to-vehicle communication (V₂V) using a vehicle communicator 1100, or the like.

In step S1670, the apparatus for controlling driving of a vehicle checks whether the following vehicle 3000 is located in the collision danger section (NO in S1650). For example, the apparatus for controlling driving of a vehicle may determine that the following vehicle 3000 is located in the collision danger section when the time to collision of the following vehicle 3000 is less than the second collision setting time.

In step S1680, when the following vehicle 3000 is located in the collision danger section (YES in S1670), the apparatus for controlling driving of a vehicle determines the lane change possibility.

In step S1690, the apparatus for controlling driving of a vehicle decelerates the host vehicle 1000 corresponding to the speed of the preceding vehicle 2000 when the following vehicle 3000 is located in a section other than the collision reserve section and the collision danger section (No in S1670).

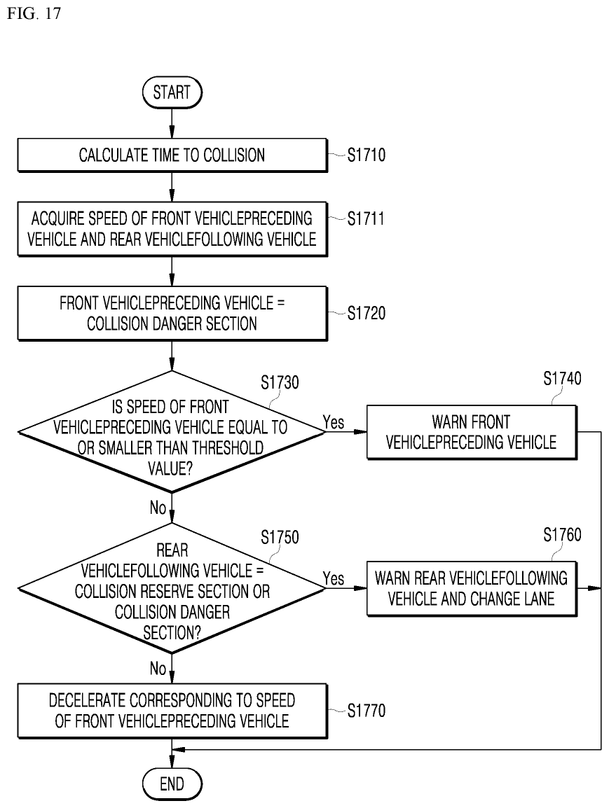

Referring to FIG. 17, in step S1710, the time to collision (TTC) calculated based on the vehicle information of the preceding vehicle 2000 and the distance between the host vehicle 1000 and the preceding vehicle 2000 is calculated, and the time to collision calculated based on the vehicle information of the following vehicle 3000 and the distance between the host vehicle 1000 and the following vehicle 3000 is calculated.

In step S1720, the apparatus for controlling driving of a vehicle checks whether the preceding vehicle 2000 is located in the collision danger section. In the present embodiment, the apparatus for controlling driving of a vehicle may determine whether or not the preceding vehicle 2000 is located in the collision danger section based on the time to collision. For example, the apparatus for controlling driving of a vehicle may determine that the preceding vehicle 2000 is located in the collision danger section when the time to collision of the preceding vehicle 2000 is less than the second collision setting time.

In step S1730, the apparatus for controlling driving of a vehicle determines whether the speed of the preceding vehicle 2000 is equal to or smaller than a threshold value. At this time, the threshold value may be set to be the road regulation speed.

In step S1740, when the speed of the preceding vehicle 2000 is equal to or smaller than the threshold value (YES in S1730), the apparatus for controlling driving of a vehicle warns the preceding vehicle 2000. In the present embodiment, examples of a method for warning a preceding vehicle 2000 include a method for rapidly blinking a lamp such as a head lamp, a method for honking a horn, or a method for issuing a warning through vehicle-to-vehicle communication (V₂V) using a vehicle communicator 1100.

In step S1750, the apparatus for controlling driving of a vehicle checks whether the following vehicle 3000 is located in the collision reserve section or the collision danger section (NO in S1730).

In step S1760, when the following vehicle 3000 is located in the collision reserve section or the collision danger section (YES in S1750), the apparatus for controlling driving of a vehicle warns the following vehicle 3000 and determines the lane change possibility. In the present embodiment, examples a method for warning a following vehicle 3000 may include a method for rapidly blinking a brake light or an emergency light while slowly decelerating, a method for issuing a warning through vehicle-to-vehicle communication (V2V) using a vehicle communicator 1100, or the like.

In step S1770, the apparatus for controlling driving of a vehicle decelerates a host vehicle 1000 corresponding to the speed of the preceding vehicle 2000 when the following vehicle 3000 is located in a section other than the collision reserve section and the collision danger section (No in S1750).

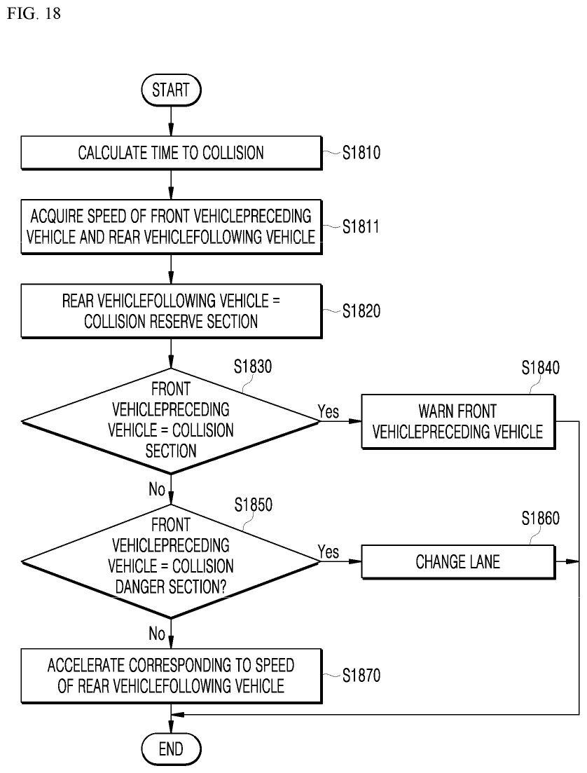

Referring to FIG. 18, in step S1810, the time to collision (TTC) calculated based on the vehicle information of the preceding vehicle 2000 and the distance between the host vehicle 1000 and the preceding vehicle 2000 is calculated, and the time to collision calculated based on the vehicle information of the following vehicle 3000 and the distance between the host vehicle 1000 and the following vehicle 3000 is calculated.

In step S1811, the apparatus for controlling driving of a vehicle acquires the speed of at least one of the preceding vehicle 2000 and the following vehicle 3000.

In step S1820, the apparatus for controlling driving of a vehicle checks whether the following vehicle 3000 is located in the collision reserve section. In the present embodiment, the apparatus for controlling driving of a vehicle may determine whether or not the following vehicle 3000 is located in the collision reserve section based on the time to collision. For example, the apparatus for controlling driving of a vehicle may determine that the following vehicle 3000 is located in the collision reserve section when the time to collision of the following vehicle 3000 is less than a first collision setting time and equal to or more than a second collision setting time.

In step S1830, the apparatus for controlling driving of a vehicle checks whether the preceding vehicle 2000 is located in the collision reserve section. For example, the apparatus for controlling driving of a vehicle may determine that the preceding vehicle 2000 is located in the collision reserve section when the time to collision of the preceding vehicle 2000 is less than the first collision setting time and equal to or more than the second collision setting time.

In step S1840, when the preceding vehicle 2000 is located in the collision reserve section (YES in S1830), the apparatus for controlling driving of a vehicle warns the preceding vehicle 2000.

In step S1850, the apparatus for controlling driving of a vehicle checks whether the preceding vehicle 2000 is located in the collision danger section (NO in S1830). For example, the apparatus for controlling driving of a vehicle may determine that the preceding vehicle 2000 is located in the collision danger section when the time to collision of the preceding vehicle 2000 is less than the second collision setting time.

In step S1860, when the preceding vehicle 2000 is located in the collision danger section (YES in S1850), the apparatus for controlling driving of a vehicle determines the lane change possibility.

In step S1870, the apparatus for controlling driving of a vehicle accelerates the host vehicle 1000 corresponding to the speed of the following vehicle 3000 when the preceding vehicle 2000 is located in a section other than the collision reserve section and the collision danger section (No in S1850).

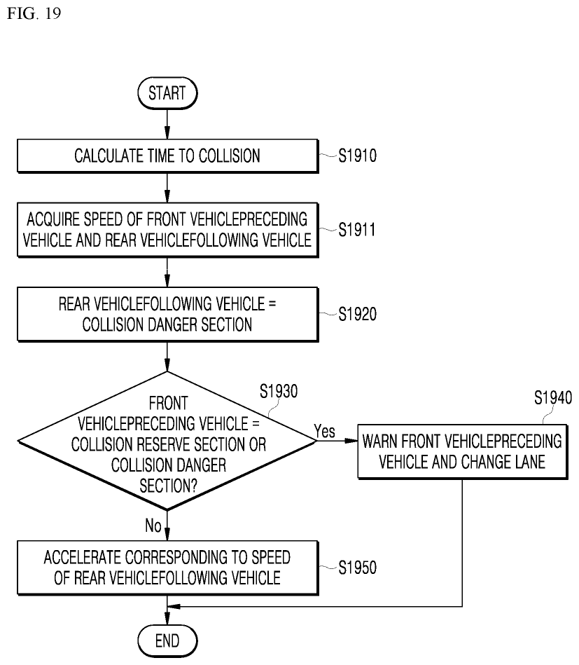

Referring to FIG. 19, in step S1910, the time to collision (TTC) calculated based on the vehicle information of the preceding vehicle 2000 and the distance between the host vehicle 1000 and the preceding vehicle 2000 is calculated, and the time to collision calculated based on the vehicle information of the following vehicle 3000 and the distance between the host vehicle 1000 and the following vehicle 3000 is calculated.

In step S1911, the apparatus for controlling driving of a vehicle acquires the speed of at least one of the preceding vehicle 2000 and the following vehicle 3000.

In step S1920, the apparatus for controlling driving of a vehicle checks whether the following vehicle 3000 is located in the collision danger section. In the present embodiment, the apparatus for controlling driving of a vehicle may determine whether or not the following vehicle 3000 is located in the collision danger section based on the time to collision. For example, the apparatus for controlling driving of a vehicle may determine that the following vehicle 3000 is located in the collision danger section when the time to collision of the following vehicle 3000 is less than the second collision setting time.

In step S1930, the apparatus for controlling driving of a vehicle checks whether the preceding vehicle 2000 is located in the collision reserve section or the collision danger section.

In step S1940, when the preceding vehicle 2000 is located in the collision reserve section or the collision danger section (YES in S1930), the apparatus for controlling driving of a vehicle warns the preceding vehicle 3000 and determines the lane change possibility.

In step S1950, the apparatus for controlling driving of a vehicle accelerates the host vehicle 1000 corresponding to the speed of the following vehicle 3000 when the preceding vehicle 2000 is located in a section other than the collision reserve section and the collision danger section (No in S1930).

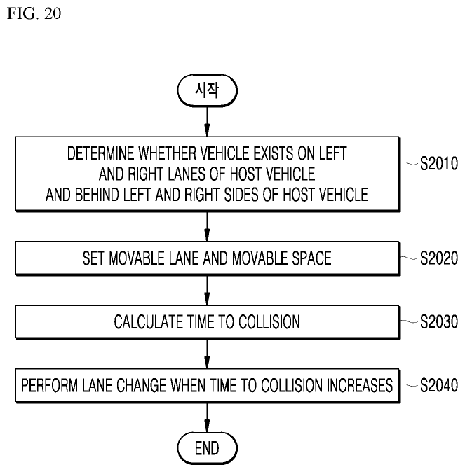

FIG. 20 is a flowchart for describing a method for determining a lane change of the apparatus for controlling a driving of a vehicle according to an embodiment of the present disclosure. In the following description, the common parts previously described with reference to FIG. 1 and FIG. 19 will not be described, so as to avoid repetitive description.

Referring to FIG. 20, in step S2010, the apparatus for controlling driving of a vehicle determines whether a lane exists on the left and right sides of the host vehicle 1000 and whether a vehicle exists behind the left and right sides of the host vehicle 1000. In this case, the apparatus for controlling driving of a vehicle may receive road information from the server or the like through the V2X communication using the vehicle communicator 1100, and may determine whether lanes exist on the left and right sides, and may also determine through HD-MAP. The HD-MAP may be stored in the vehicle storage 1800 or downloaded from the server or the like through the vehicle communicator 1100.

In step S2020, the apparatus for controlling driving of a vehicle sets a movable lane of the host vehicle 1000 and a movable space of the movable lane.

In step S2030, the apparatus for controlling driving of a vehicle calculates a time to collision calculated based on vehicle information of a following vehicle 3000a of the movable lane and a distance between a reference point of the movable space and the following vehicle 3000a. In this case, the apparatus for controlling driving of a vehicle may check and track whether a vehicle exists behind a lane existing on the left and right sides of the host vehicle 1000 to determine whether a lane is changed. That is, the apparatus for controlling driving of a vehicle may acquire and track the vehicle information of the approaching vehicle for a predetermined time, acquire the road traffic information from the ITS server for a predetermined time, and analyze the driving pattern of the approaching vehicle based on the tracking information and the road traffic information of the approaching vehicle for a predetermined time.

In step S2040, when the time to collision increases, the apparatus for controlling driving of a vehicle may perform the lane change of the host vehicle 1000 to the movable lane. In the present embodiment, after the apparatus for controlling driving of a vehicle may change a lane, and then may check the vehicle close to the corresponding lane again and perform adaptive driving control.

Embodiments according to the present disclosure described above may be implemented in the form of a computer program that can be executed through various components on a computer, and such a computer program may be recorded in a computer-readable medium. For example, the recording media may include magnetic media such as hard disks, floppy disks, and magnetic media such as a magnetic tape, optical media such as CD-ROMs and DVDs, magneto-optical media such as floptical disks, and hardware devices specifically configured to store and execute program commands, such as ROM, RAM, and flash memory.

Meanwhile, the computer programs may be those specially designed and constructed for the purposes of the present disclosure or they may be of the kind well known and available to those skilled in the computer software arts. The computer programs may include not only machine languages compiled by a compiler but also high-level language codes capable of being executed by a computer using an interpreter.

As used in the present application (especially in the appended claims), the terms “a/an” and “the” include both singular and plural references, unless the context clearly states otherwise. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

The above-mentioned steps constructing the method disclosed in the present disclosure may be performed in a proper order unless explicitly stated otherwise. However, the scope or spirit of the present disclosure is not limited thereto. All examples described herein or the terms indicative thereof (“for example,” and the like) used herein are merely to describe the present disclosure in greater detail. Therefore, it should be understood that the scope of the present disclosure is not limited to the example embodiments described above or by the use of such terms unless limited by the appended claims.

Also, it should be apparent to those skilled in the art that various alterations, substitutions, and modifications may be made within the scope of the appended claims or equivalents thereof.

Therefore, technical ideas of the present disclosure are not limited to the above-mentioned embodiments, and it is intended that not only the appended claims, but also all changes equivalent to claims, should be considered to fall within the scope of the present disclosure.

What is claimed is:

1. A method for controlling an apparatus for controlling driving of a vehicle, comprising:
checking approaching vehicles located in a predetermined distance with respect to a host vehicle;
acquiring at least one of driving environment information comprising vehicle information of the host vehicle and road traffic information, vehicle information of a preceding vehicle located in front of the host vehicle among the approaching vehicles, or vehicle information of a following vehicle located behind the host vehicle;
controlling the host vehicle in an adaptive cruise mode so that a distance between the host vehicle and the preceding vehicle or the following vehicle is maintained within a predetermined distance based on the driving environment information of the host vehicle and the vehicle information of the preceding vehicle or the following vehicle; and
controlling the host vehicle in an adaptive avoidance mode when the distance between the host vehicle and the preceding vehicle, or the distance between the host vehicle and the following vehicle is not maintained within the predetermined distance.

2. The method of claim 1, wherein the acquiring comprises:
receiving the driving environment information of the host vehicle and the vehicle information of the preceding vehicle and the following vehicle based on a downlink grant of a 5G network connected to operate the host vehicle equipped with the apparatus for controlling driving of a vehicle in an autonomous driving mode, and
at least a part of the driving environment information of the host vehicle is received from an intelligent transport system (ITS) server connected to the 5G network.

3. The method of claim 1, wherein the controlling of the host vehicle in the adaptive avoidance mode comprises:
calculating at least one of a time to collision (TTC) calculated based on the vehicle information of the preceding vehicle and the distance between the host vehicle and the preceding vehicle, or a time to collision calculated based on the vehicle information of the following vehicle and the distance between the host vehicle and the following vehicle; and
determining that at least one of the preceding vehicle or the following vehicle is located in a collision reserve section based on the time to collision, or
determining that at least one of the preceding vehicle or the following vehicle is located in the collision danger section.

4. The method of claim 3, wherein the controlling of the host vehicle in the adaptive avoidance mode comprises:
warning the preceding vehicle when the preceding vehicle is located in the collision reserve section and a speed of the preceding vehicle is equal to or smaller than a threshold value;
decelerating the host vehicle corresponding to the speed of the preceding vehicle when the preceding vehicle is located in the collision reserve section and the following vehicle is located in a section other than the collision reserve section and the collision danger section;
warning the following vehicle when the preceding vehicle is located in the collision reserve section and the following vehicle is located in the collision reserve section; and
determining whether the host vehicle performs a lane change when the preceding vehicle is located in the collision reserve section and the following vehicle is located in the collision danger section.

5. The method of claim 3, wherein the controlling of the host vehicle in the adaptive avoidance mode comprises:
warning the preceding vehicle when the preceding vehicle is located in the collision danger section and the speed of the preceding vehicle is equal to or smaller than the threshold value;
decelerating the host vehicle corresponding to the speed of the preceding vehicle when the preceding vehicle is located in the collision danger section and the following vehicle is located in the section other than the collision reserve section and the collision danger section; and
warning the following vehicle and determining whether the host vehicle performs a lane change when the preceding vehicle is located in the collision danger section and the following vehicle is located in the collision reserve section or the collision danger section.

6. The method of claim 3, wherein the controlling of the host vehicle in the adaptive avoidance mode comprises:
accelerating the host vehicle corresponding to a speed of the following vehicle when the following vehicle is located in the collision reserve section and the preceding vehicle is located in the section other than the collision reserve section and the collision danger section;
warning the preceding vehicle when the following vehicle is located in the collision reserve section and the preceding vehicle is located in the collision reserve section; and
determining whether the host vehicle performs a lane change when the following vehicle is located in the collision reserve section and the preceding vehicle is located in the collision danger section.

7. The method of claim 3, wherein the controlling of the host vehicle in the adaptive avoidance mode comprises:
accelerating the host vehicle corresponding to a speed of the following vehicle when the following vehicle is located in the collision danger section and the preceding vehicle is located in the section other than the collision reserve section and the collision danger section; and
warning the following vehicle and determining whether the host vehicle performs a lane change when the following vehicle is located in the collision danger section and the following vehicle is located in the collision reserve section or the collision danger section.

8. The method of claim 4, wherein the determining whether the host vehicle performs the lane change comprises:
determining whether a lane exists on left and right sides of the host vehicle and a vehicle exists behind the left and right sides of the host vehicle;
setting a movable lane of the host vehicle and a movable space of the movable lane;
calculating a time to collision based on the vehicle information of the following vehicle of the movable lane, and a distance between a reference point of the movable space and the following vehicle; and
performing the lane change of the host vehicle to the lane when the time to collision increases.

9. The method of claim 1, wherein the checking of the approaching vehicle comprises:
acquiring and tracking the vehicle information of the approaching vehicle for a predetermined time;
acquiring road traffic information from the ITS server for the predetermined time; and
analyzing a driving pattern of the approaching vehicle based on the tracking information and the road traffic information of the approaching vehicle for the predetermined time.

10. The method of claim 1, further comprising:
receiving, as input data, the vehicle information of the host vehicle, road traffic information from the ITS server, and vehicle information of the approaching vehicle located within the predetermined distance with respect to the host vehicle;
applying the received input data to a learning model to extract adaptive driving data of the host vehicle in response to a change in space around the host vehicle; and
outputting the adaptive driving data in response to the change in space around the host vehicle from the learning model,
wherein the learning model is trained to generate the adaptive driving data according to the adaptive cruise mode or the adaptive avoidance mode based on the pre-calculated change state in space around the host vehicle and the plurality of pre-input data to correspond to the vehicle information of the host vehicle and the road traffic information and vehicle information data of the approaching vehicle, respectively, which are input in advance to recognize the change in space around the host vehicle.

11. An apparatus for controlling driving of a vehicle, comprising:
an approaching vehicle tracker configured to check approaching vehicles located in a predetermined distance with respect to a host vehicle;
an acquirer configured to acquire at least one of driving environment information including vehicle information of the host vehicle and road traffic information, vehicle information of a preceding vehicle located in front of the host vehicle among the approaching vehicles, or vehicle information of a following vehicle located behind the host vehicle; and
an adaptive driving controller configured to control the host vehicle in an adaptive cruise mode so that a distance between the host vehicle and the preceding vehicle or the following vehicle is maintained within a predetermined distance, based on the driving environment information of the host vehicle and the vehicle information of the preceding vehicle or the following vehicle, and control the host vehicle in an adaptive avoidance mode when the set distance between the host vehicle and the preceding vehicle or the distance between the host vehicle and the following vehicle is not maintained within the predetermined distance.

12. The apparatus of claim 11, wherein the acquirer receives the driving environment information of the host vehicle and the vehicle information of at least one of the preceding vehicle or the following vehicle based on a downlink grant of a 5G network connected to operate the host vehicle equipped with the apparatus for controlling driving of a vehicle in an autonomous driving mode, and
at least a part of the driving environment information of the host vehicle is received from an intelligent transport system (ITS) server connected to the 5G network.

13. The apparatus of claim 11, further comprising:
a TTC calculator configured to calculate at least one of a time to collision (TTC) calculated based on the vehicle information of the preceding vehicle and the distance between the host vehicle and the preceding vehicle, or a time to collision calculated based on the vehicle information of the following vehicle and the distance between the host vehicle and the following vehicle; and
a collision determiner configured to determine that at least one of the preceding vehicle or the following vehicle is located in a collision reserve section based on the time to collision or determine that at least one of the preceding vehicle or the following vehicle is located in a collision danger section.

14. The apparatus of claim 13, wherein the adaptive driving controller is configured to warn the preceding vehicle when the preceding vehicle is located in the collision reserve section and a speed of the preceding vehicle is equal to or smaller than a threshold value,
decelerate the host vehicle corresponding to the speed of the preceding vehicle when the preceding vehicle is located in the collision reserve section and the following vehicle is located in a section other than the collision reserve section and the collision danger section,
warn the following vehicle when the preceding vehicle is located in the collision reserve section and the following vehicle is located in the collision reserve section, and
determine whether the host vehicle performs a lane change when the preceding vehicle is located in the collision reserve section and the following vehicle is located in the collision danger section.

15. The apparatus of claim 13, wherein the adaptive driving controller is configured to warn the preceding vehicle when the preceding vehicle is located in the collision danger section and a speed of the preceding vehicle is equal to or smaller than a threshold value,
decelerate the host vehicle corresponding to the speed of the preceding vehicle when the preceding vehicle is located in the collision danger section and the following vehicle is located in a section other than the collision reserve section and the collision danger section, and
warn the following vehicle and determine whether the host vehicle performs a lane change when the preceding vehicle is located in the collision danger section and the following vehicle is located in the collision reserve section or the collision danger section.

16. The apparatus of claim 13, wherein the adaptive driving controller is configured to accelerate the host vehicle corresponding to a speed of the following vehicle when the following vehicle is located in the collision reserve section and the preceding vehicle is located in a section other than the collision reserve section and the collision danger section,
warn the preceding vehicle when the following vehicle is located in the collision reserve section and the preceding vehicle is located in the collision reserve section, and
determine whether the host vehicle performs a lane change when the following vehicle is located in the collision reserve section and the preceding vehicle is located in the collision danger section.

17. The apparatus of claim 13, wherein the adaptive driving controller is configured to accelerate the host vehicle corresponding to a speed of the following vehicle when the following vehicle is located in the collision danger section and the preceding vehicle is located in a section other than the collision reserve section and the collision danger section, and
warn the following vehicle and determining whether the host vehicle performs a lane change when the following vehicle is located in the collision danger section and the following vehicle is located in the collision reserve section or the collision danger section.

18. The apparatus of claim 14, further comprising:
a lane change determiner configured to determine whether a lane exists on left and right sides of the host vehicle and a vehicle exists behind the left and right sides of the host vehicle, set a movable lane of the host vehicle and a movable space of the movable lane, and calculate a time to collision based on the vehicle information of the following vehicle of the movable lane, and a distance between a reference point of the movable space and the following vehicle, and
wherein the adaptive driving controller performs the lane change of the host vehicle to the lane when the time to collision increases.

19. The apparatus of claim 11, further comprising:
an approaching vehicle tracker configured to acquire and track the vehicle information of the approaching vehicle for a predetermined time, acquire road traffic information from the ITS server for the predetermined time, and analyze a driving pattern of the approaching vehicle based on the tracking information and the road traffic information of the approaching vehicle for the predetermined time.

20. The apparatus of claim 11, further comprising:
an inputter configured to receive, as input data, the vehicle information of the host vehicle, the road traffic information from the ITS server, and the vehicle information of the approaching vehicle located within the predetermined distance with respect to the host vehicle;
a learning processor configured to apply the received input data to a learning model to extract adaptive driving data of the host vehicle in response to a change in space around the host vehicle; and
an outputter configured to output the adaptive driving data in response to the change in space around the host vehicle from the learning model,
wherein the learning model is trained to generate the adaptive driving data according to the adaptive cruise mode or the adaptive avoidance mode based on the pre-calculated change state in space around the host vehicle and the plurality of pre-input data to correspond to the vehicle information of the host vehicle and the road traffic information and vehicle information data of the approaching vehicle, respectively, which are input in advance to recognize the change in space around the host vehicle.
